(19) United States
(12) Patent Application Publication
(10) Pub. No.: US 2026/0189288 A1
(43) Pub. Date: Jul. 2, 2026

(54) MULTIPLE RESOURCE ALLOCATION REQUESTS IN USER EQUIPMENT (UE)-INITIATED BEAM REPORTING

(71) Applicant: QUALCOMM Incorporated, San Diego, CA (US)

(72) Inventors: Kiran VENUGOPAL, Green Brook, NJ (US); Yu ZHANG, San Diego, CA (US); Yan ZHOU, San Diego, CA (US); Jing SUN, San Diego, CA (US)

(21) Appl. No.: 19/008,366

(22) Filed: Jan. 2, 2025

(51) Int. Cl. H04B 7/06; H04L 27/26; H04W 72/21

(52) U.S. Cl. CPC H04B 7/06952; H04L 27/26025; H04W 72/21

(57) ABSTRACT

Methods, systems, and devices for wireless communications are described. Various aspects relate to mechanisms according to which a user equipment (UE) may manage multiple resource allocation requests in UE-initiated beam reporting. Some aspects more specifically relate to a timer that restricts resource allocation requests associated with UE-initiated uplink beam reporting. Some aspects more specifically relate to mechanisms according to which the UE operates in scenarios in which conditions associated with downlink and uplink UE-initiated beam reporting are satisfied within a threshold duration of each other. Some aspects more specifically relate to one or more mechanisms according to which the UE operates in scenarios in which the UE transmits a first resource allocation request associated with a first type of UE-initiated beam reporting and detects, prior to receiving a corresponding resource grant, that a condition associated with a second type of UE-initiated beam reporting is also satisfied.

### FIELD OF TECHNOLOGY

The following relates to wireless communications, including multiple resource allocation requests in user equipment (UE)-initiated beam reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may communicate with a base station using directional communication. For example, the UE and the base station may communicate via one or more directional beams, which may be understood as one or more configurations associated with directional communication. In some systems, a transmission configuration indicator (TCI) state may indicate a configuration associated with directional communication. A TCI state may indicate, provide, or define a quasi-collocation (QCL) relationship between a downlink reference signal and a set of antenna ports that a UE may use to transmit or receive directional communication. For example, a UE may use an active TCI state to select a set of antenna ports that the UE may use to transmit or receive communication in a direction associated with a downlink reference signal that corresponds to the TCI state.

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a first uplink resource allocation request associated with an uplink beam report in accordance with a satisfaction of a condition associated with UE-initiated uplink beam reporting at the UE, monitoring, within a time period indicated by a timer that restricts uplink resource allocation requests associated with UE-initiated uplink beam reports, a downlink control channel for a resource grant associated with the uplink beam report in accordance with transmitting the first uplink resource allocation request, and transmitting a second uplink resource allocation request associated with the uplink beam report in accordance with an absence of the resource grant and an expiration of the timer that restricts the uplink resource allocation requests associated with the UE-initiated uplink beam reports.

A UE for wireless communications is described. The UE may include one or more memories storing processor executable code, and one or more processors coupled with the one or more memories. The one or more processors may individually or collectively be operable to execute the code to cause the UE to transmit a first uplink resource allocation request associated with an uplink beam report in accordance with a satisfaction of a condition associated with UE-initiated uplink beam reporting at the UE, monitor, within a time period indicated by a timer that restricts uplink resource allocation requests associated with UE-initiated uplink beam reports, a downlink control channel for a resource grant associated with the uplink beam report in accordance with transmitting the first uplink resource allocation request, and transmit a second uplink resource allocation request associated with the uplink beam report in accordance with an absence of the resource grant and an expiration of the timer that restricts the uplink resource allocation requests associated with the UE-initiated uplink beam reports.

Some examples of the methods and UEs described herein may further include operations, features, means, or instructions for receiving, via control signaling, an indication of the timer that restricts the uplink resource allocation requests associated with the UE-initiated uplink beam reports.

Some examples of the methods and UEs described herein may further include operations, features, means, or instructions for receiving an indication of a subcarrier spacing associated with communications at the UE, where the time period indicated by the timer that restricts the uplink resource allocation requests associated with the UE-initiated uplink beam reports may be in accordance with the subcarrier spacing.

In some examples of the methods and UEs described herein, the time period indicated by the timer that restricts the uplink resource allocation requests associated with the UE-initiated uplink beam reports may be fixed and applicable to a set of multiple UEs of a wireless communications system including the UE.

Some examples of the methods and UEs described herein may further include operations, features, means, or instructions for transmitting up to a threshold quantity of uplink resource allocation requests associated with the uplink beam report in accordance with a continued absence of the resource grant and initiating a beam failure recovery procedure based on a failure to receive the resource grant in accordance with transmitting the threshold quantity of uplink resource allocation requests.

Some examples of the methods and UEs described herein may further include operations, features, means, or instructions for transmitting a set of multiple uplink resource allocation requests associated with the uplink beam report in accordance with a continued absence of the resource grant until a threshold time period from the first uplink resource allocation request may be exceeded and initiating a beam failure recovery procedure based on a failure to receive the resource grant in accordance with transmitting the set of multiple uplink resource allocation requests until the threshold time period from the first uplink resource allocation request may be exceeded.

In some examples of the methods and UEs described herein, the uplink beam report includes information indicative of one or more uplink metrics associated with one or more reference signals.

In some examples of the methods and UEs described herein, the time period indicated by the timer starts from a first time at which the UE transmits the first uplink resource allocation request or from an offset relative to the first time and the timer expires at or prior to a second time at which the UE transmits the second uplink resource allocation request.

A method for wireless communications by a UE is described. The method may include transmitting one or more uplink resource allocation requests associated with an uplink beam report, a downlink beam report, or both in accordance with a first satisfaction of a first condition associated with UE-initiated uplink beam reporting at the UE and a second satisfaction of a second condition associated with UE-initiated downlink beam reporting at the UE, where the first satisfaction of the first condition and the second satisfaction of the second condition occur within a threshold duration of each other, receiving one or more resource grants associated with the uplink beam report, the downlink beam report, or both in accordance with transmitting the one or more uplink resource allocation requests, and transmitting, via a set of uplink resources allocated by the one or more resource grants, the uplink beam report, the downlink beam report, or both.

A UE for wireless communications is described. The UE may include one or more memories storing processor executable code, and one or more processors coupled with the one or more memories. The one or more processors may individually or collectively be operable to execute the code to cause the UE to transmit one or more uplink resource allocation requests associated with an uplink beam report, a downlink beam report, or both in accordance with a first satisfaction of a first condition associated with UE-initiated uplink beam reporting at the UE and a second satisfaction of a second condition associated with UE-initiated downlink beam reporting at the UE, where the first satisfaction of the first condition and the second satisfaction of the second condition occur within a threshold duration of each other, receive one or more resource grants associated with the uplink beam report, the downlink beam report, or both in accordance with transmitting the one or more uplink resource allocation requests, and transmit, via a set of uplink resources allocated by the one or more resource grants, the uplink beam report, the downlink beam report, or both.

In some examples of the methods and UEs described herein, transmitting the one or more uplink resource allocation requests may include operations, features, means, or instructions for transmitting a first uplink resource allocation request associated with the uplink beam report in accordance with the first satisfaction of the first condition and transmitting a second uplink resource allocation request associated with the downlink beam report in accordance with the second satisfaction of the second condition.

Some examples of the methods and UEs described herein may further include operations, features, means, or instructions for transmitting the first uplink resource allocation request and the second uplink resource allocation request may be in accordance with a rule and the rule defines separate uplink resource allocation requests associated with the UE-initiated uplink beam reporting and the UE-initiated downlink beam reporting independent of a timing between the first satisfaction of the first condition and the second satisfaction of the second condition.

In some examples of the methods and UEs described herein, receiving the one or more resource grants may include operations, features, means, or instructions for receiving a first resource grant associated with the uplink beam report, where the first resource grant allocates a first set of uplink resources via which the UE transmits the uplink beam report and receiving a second resource grant associated with the downlink beam report, where the second resource grant allocates a second set of uplink resources via which the UE transmits the downlink beam report.

In some examples of the methods and UEs described herein, the UE-initiated uplink beam reporting may be associated with a first set of one or more timers, a first set of one or more configurations, or a first set of one or more resources and the UE-initiated downlink beam reporting may be associated with a second set of one or more timers, a second set of one or more configurations, or a second set of one or more resources.

In some examples of the methods and UEs described herein, transmitting the one or more uplink resource allocation requests may include operations, features, means, or instructions for transmitting a single uplink resource allocation request in accordance with the first satisfaction of the first condition and the second satisfaction of the second condition occurring within the threshold duration of each other.

In some examples of the methods and UEs described herein, receiving the one or more resource grants may include operations, features, means, or instructions for receiving a single resource grant in accordance with transmitting the single uplink resource allocation request, where the single resource grant allocates the set of uplink resources, and where the UE transmits the uplink beam report, the downlink beam report, or both as an uplink-only beam report, a downlink-only beam report, or a joint uplink and downlink beam report.

Some examples of the methods and UEs described herein may further include operations, features, means, or instructions for selecting the uplink beam report, the downlink beam report, or both for transmission via the set of uplink resources in accordance with an autonomous UE decision or a relative priority between the uplink beam report and the downlink beam report.

In some examples of the methods and UEs described herein, transmitting the one or more uplink resource allocation requests may include operations, features, means, or instructions for transmitting a single uplink resource allocation request via a first uplink control channel resource, of a set of multiple uplink control channel resources, in accordance with the first satisfaction of the first condition and the second satisfaction of the second condition occurring within the threshold duration of each other, where the first uplink control channel resource indicates that a requested resource may be associated with a joint uplink and downlink beam report, and where other uplink control channel resources of the set of multiple uplink control channel resources indicate that the requested resource may be associated with an uplink-only beam report or a downlink-only beam report.

In some examples of the methods and UEs described herein, receiving the one or more resource grants may include operations, features, means, or instructions for receiving a single resource grant in accordance with transmitting the single uplink resource allocation request, where the single resource grant allocates the set of uplink resources, and where the UE transmits the uplink beam report and the downlink beam report as the joint uplink and downlink beam report in accordance with transmitting the single uplink resource allocation request via the first uplink control channel resource.

Some examples of the methods and UEs described herein may further include operations, features, means, or instructions for receiving, via control signaling, an indication of the first uplink control channel resource that indicates that the requested resource may be associated with the joint uplink and downlink beam report, where the control signaling configures the first uplink control channel resource as a periodic uplink control channel resource or a semi-persistent uplink control channel resource.

In some examples of the methods and UEs described herein, transmitting the one or more uplink resource allocation requests may include operations, features, means, or instructions for transmitting a single uplink resource allocation request in accordance with the first satisfaction of the first condition and the second satisfaction of the second condition occurring within the threshold duration of each other, where the single uplink resource allocation request includes an indication, via one or more bits of the single uplink resource allocation request, that the first satisfaction of the first condition and the second satisfaction of the second condition occurred within the threshold duration of each other.

In some examples of the methods and UEs described herein, receiving the one or more resource grants may include operations, features, means, or instructions for receiving a single resource grant in accordance with the indication, where the single resource grant allocates the set of uplink resources, and where the UE transmits the uplink beam report and the downlink beam report as a joint uplink and downlink beam report.

In some examples of the methods and UEs described herein, a bitword associated with the one or more bits indicates whether a requested resource may be associated with an uplink-only beam report, a downlink-only beam report, or a joint uplink and downlink beam report.

In some examples of the methods and UEs described herein, the uplink beam report includes first information indicative of one or more uplink metrics associated with one or more first reference signals and the downlink beam report includes second information indicative of one or more downlink metrics associated with one or more second reference signals.

In some examples of the methods and UEs described herein, the threshold duration may be defined by a difference between a first time at which the first satisfaction of the first condition or the second satisfaction of the second condition occurs and a second time at which the UE transmits the one or more uplink resource allocation requests, or may be defined by a timer that restricts resource allocation requests associated with UE-initiated uplink beam reports or UE-initiated downlink beam reports.

A method for wireless communications by a UE is described. The method may include transmitting a first uplink resource allocation request associated with a first beam report in accordance with a first satisfaction of a first condition associated with a first type of UE-initiated beam reporting at the UE, receiving a first resource grant associated with the first beam report in accordance with transmitting the first uplink resource allocation request, and transmitting, via at least a first set of uplink resources allocated by the first resource grant, the first beam report, a second beam report, or both in accordance with a second satisfaction, prior to receiving the first resource grant, of a second condition associated with a second type of UE-initiated beam reporting at the UE.

A UE for wireless communications is described. The UE may include one or more memories storing processor executable code, and one or more processors coupled with the one or more memories. The one or more processors may individually or collectively be operable to execute the code to cause the UE to transmit a first uplink resource allocation request associated with a first beam report in accordance with a first satisfaction of a first condition associated with a first type of UE-initiated beam reporting at the UE, receive a first resource grant associated with the first beam report in accordance with transmitting the first uplink resource allocation request, and transmit, via at least a first set of uplink resources allocated by the first resource grant, the first beam report, a second beam report, or both in accordance with a second satisfaction, prior to receiving the first resource grant, of a second condition associated with a second type of UE-initiated beam reporting at the UE.

Some examples of the methods and UEs described herein may further include operations, features, means, or instructions for transmitting a second uplink resource allocation request associated with the second beam report in accordance with the second satisfaction of the second condition associated with the second type of UE-initiated beam reporting at the UE and receiving a second resource grant associated with the second beam report in accordance with transmitting the second uplink resource allocation request.

In some examples of the methods and UEs described herein, transmitting the first beam report, the second beam report, or both may include operations, features, means, or instructions for transmitting the first beam report via the first set of uplink resources allocated by the first resource grant and transmitting the second beam report via a second set of uplink resources allocated by the second resource grant.

Some examples of the methods and UEs described herein may further include operations, features, means, or instructions for multiplexing a second uplink resource allocation request associated with the second beam report with the first beam report and receiving a second resource grant associated with the second beam report in accordance with multiplexing the second uplink resource allocation request with the first beam report.

In some examples of the methods and UEs described herein, transmitting the first beam report, the second beam report, or both may include operations, features, means, or instructions for transmitting the first beam report and the second uplink resource allocation request via the first set of uplink resources allocated by the first resource grant and transmitting the second beam report via a second set of uplink resources allocated by the second resource grant.

Some examples of the methods and UEs described herein may further include operations, features, means, or instructions for multiplexing the first beam report and the second beam report to the first set of uplink resources allocated by the first resource grant, where the UE allocates uplink resources, from the first set of uplink resources, to the first beam report and the second beam report in accordance with a relative priority between the first beam report and the second beam report.

In some examples of the methods and UEs described herein, the UE prioritizes resource allocation to the first beam report in accordance with the first beam report having a higher priority than the second beam report.

In some examples of the methods and UEs described herein, the UE transmits the first beam report and the second beam report via the first set of uplink resources allocated by the first resource grant as a joint beam report.

In some examples of the methods and UEs described herein, the first beam report may be a downlink beam report, and the first type of UE-initiated beam reporting may be UE-initiated downlink beam reporting and the second beam report may be an uplink beam report, and the second type of UE-initiated beam reporting may be UE-initiated uplink beam reporting.

In some examples of the methods and UEs described herein, the first beam report may be an uplink beam report, and the first type of UE-initiated beam reporting may be UE-initiated uplink beam reporting and the second beam report may be a downlink beam report, and the second type of UE-initiated beam reporting may be UE-initiated downlink beam reporting.

A method for wireless communications by a network entity is described. The method may include receiving a first uplink resource allocation request associated with an uplink beam report in accordance with a satisfaction of a condition associated with UE-initiated uplink beam reporting at a UE, transmitting, within a time period indicated by a timer that restricts uplink resource allocation requests associated with UE-initiated uplink beam reports, a resource grant associated with the uplink beam report in accordance with receiving the first uplink resource allocation request, and receiving a second uplink resource allocation request associated with the uplink beam report in accordance with a reception failure of the resource grant at the UE and an expiration of the timer that restricts the uplink resource allocation requests associated with the UE-initiated uplink beam reports.

A network entity for wireless communications is described. The network entity may include one or more memories storing processor executable code, and one or more processors coupled with the one or more memories. The one or more processors may individually or collectively be operable to execute the code to cause the network entity to receive a first uplink resource allocation request associated with an uplink beam report in accordance with a satisfaction of a condition associated with UE-initiated uplink beam reporting at a UE, transmit, within a time period indicated by a timer that restricts uplink resource allocation requests associated with UE-initiated uplink beam reports, a resource grant associated with the uplink beam report in accordance with receiving the first uplink resource allocation request, and receive a second uplink resource allocation request associated with the uplink beam report in accordance with a reception failure of the resource grant at the UE and an expiration of the timer that restricts the uplink resource allocation requests associated with the UE-initiated uplink beam reports.

Some examples of the methods and network entities described herein may further include operations, features, means, or instructions for transmitting, via control signaling, an indication of the timer that restricts the uplink resource allocation requests associated with the UE-initiated uplink beam reports.

Some examples of the methods and network entities described herein may further include operations, features, means, or instructions for transmitting an indication of a subcarrier spacing associated with communications at the UE, where the time period indicated by the timer that restricts the uplink resource allocation requests associated with the UE-initiated uplink beam reports may be in accordance with the subcarrier spacing.

In some examples of the methods and network entities described herein, the time period indicated by the timer that restricts the uplink resource allocation requests associated with the UE-initiated uplink beam reports may be fixed and applicable to a set of multiple UEs of a wireless communications system including the UE.

Some examples of the methods and network entities described herein may further include operations, features, means, or instructions for receiving up to a threshold quantity of uplink resource allocation requests associated with the uplink beam report in accordance with a continued reception failure of the resource grant at the UE and participating in a beam failure recovery procedure with the UE based on receiving the threshold quantity of uplink resource allocation requests.

Some examples of the methods and network entities described herein may further include operations, features, means, or instructions for receiving a set of multiple uplink resource allocation requests associated with the uplink beam report in accordance with a continued reception failure of the resource grant at the UE until a threshold time period from the first uplink resource allocation request may be exceeded and participating in a beam failure recovery procedure with the UE based on the threshold time period from the first uplink resource allocation request being exceeded prior to a successful reception of the resource grant at the UE.

In some examples of the methods and network entities described herein, the uplink beam report includes information indicative of one or more uplink metrics associated with one or more reference signals.

In some examples of the methods and network entities described herein, the time period indicated by the timer starts from a first time at which the network entity receives the first uplink resource allocation request or from an offset relative to the first time and the timer expires at or prior to a second time at which the network entity receives the second uplink resource allocation request.

A method for wireless communications by a network entity is described. The method may include receiving one or more uplink resource allocation requests associated with an uplink beam report, a downlink beam report, or both in accordance with a first satisfaction of a first condition associated with UE-initiated uplink beam reporting at a UE and a second satisfaction of a second condition associated with UE-initiated downlink beam reporting at the UE, where the first satisfaction of the first condition and the second satisfaction of the second condition occur within a threshold duration of each other, transmitting one or more resource grants associated with the uplink beam report, the downlink beam report, or both in accordance with receiving the one or more uplink resource allocation requests, and receiving, via a set of uplink resources allocated by the one or more resource grants, the uplink beam report, the downlink beam report, or both.

A network entity for wireless communications is described. The network entity may include one or more memories storing processor executable code, and one or more processors coupled with the one or more memories. The one or more processors may individually or collectively be operable to execute the code to cause the network entity to receive one or more uplink resource allocation requests associated with an uplink beam report, a downlink beam report, or both in accordance with a first satisfaction of a first condition associated with UE-initiated uplink beam reporting at a UE and a second satisfaction of a second condition associated with UE-initiated downlink beam reporting at the UE, where the first satisfaction of the first condition and the second satisfaction of the second condition occur within a threshold duration of each other, transmit one or more resource grants associated with the uplink beam report, the downlink beam report, or both in accordance with receiving the one or more uplink resource allocation requests, and receive, via a set of uplink resources allocated by the one or more resource grants, the uplink beam report, the downlink beam report, or both.

In some examples of the methods and network entities described herein, receiving the one or more uplink resource allocation requests may include operations, features, means, or instructions for receiving a first uplink resource allocation request associated with the uplink beam report in accordance with the first satisfaction of the first condition and receiving a second uplink resource allocation request associated with the downlink beam report in accordance with the second satisfaction of the second condition.

Some examples of the methods and network entities described herein may further include operations, features, means, or instructions for receiving the first uplink resource allocation request and the second uplink resource allocation request may be in accordance with a rule and the rule defines separate uplink resource allocation requests associated with the UE-initiated uplink beam reporting and the UE-initiated downlink beam reporting independent of a timing between the first satisfaction of the first condition and the second satisfaction of the second condition.

In some examples of the methods and network entities described herein, transmitting the one or more resource grants may include operations, features, means, or instructions for transmitting a first resource grant associated with the uplink beam report, where the first resource grant allocates a first set of uplink resources via which the UE may be to transmit the uplink beam report and transmitting a second resource grant associated with the downlink beam report, where the second resource grant allocates a second set of uplink resources via which the UE may be to transmit the downlink beam report.

In some examples of the methods and network entities described herein, the UE-initiated uplink beam reporting may be associated with a first set of one or more timers, a first set of one or more configurations, or a first set of one or more resources and the UE-initiated downlink beam reporting may be associated with a second set of one or more timers, a second set of one or more configurations, or a second set of one or more resources.

In some examples of the methods and network entities described herein, receiving the one or more uplink resource allocation requests may include operations, features, means, or instructions for receiving a single uplink resource allocation request in accordance with the first satisfaction of the first condition and the second satisfaction of the second condition occurring within the threshold duration of each other.

In some examples of the methods and network entities described herein, transmitting the one or more resource grants may include operations, features, means, or instructions for transmitting a single resource grant in accordance with receiving the single uplink resource allocation request, where the single resource grant allocates the set of uplink resources, and where the network entity receives the uplink beam report, the downlink beam report, or both as an uplink-only beam report, a downlink-only beam report, or a joint uplink and downlink beam report.

In some examples of the methods and network entities described herein, receiving the uplink beam report, the downlink beam report, or both may include operations, features, means, or instructions for receiving the uplink beam report, the downlink beam report, or both via the set of uplink resources in accordance with an autonomous UE decision or a relative priority between the uplink beam report and the downlink beam report.

In some examples of the methods and network entities described herein, receiving the one or more uplink resource allocation requests may include operations, features, means, or instructions for receiving a single uplink resource allocation request via a first uplink control channel resource, of a set of multiple uplink control channel resources, in accordance with the first satisfaction of the first condition and the second satisfaction of the second condition occurring within the threshold duration of each other, where the first uplink control channel resource indicates that a requested resource may be associated with a joint uplink and downlink beam report, and where other uplink control channel resources of the set of multiple uplink control channel resources indicate that the requested resource may be associated with an uplink-only beam report or a downlink-only beam report.

In some examples of the methods and network entities described herein, transmitting the one or more resource grants may include operations, features, means, or instructions for transmitting a single resource grant in accordance with receiving the single uplink resource allocation request, where the single resource grant allocates the set of uplink resources, and where the network entity receives the uplink beam report and the downlink beam report as the joint uplink and downlink beam report in accordance with receiving the single uplink resource allocation request via the first uplink control channel resource.

Some examples of the methods and network entities described herein may further include operations, features, means, or instructions for transmitting, via control signaling, an indication of the first uplink control channel resource that indicates that the requested resource may be associated with the joint uplink and downlink beam report, where the control signaling configures the first uplink control channel resource as a periodic uplink control channel resource or a semi-persistent uplink control channel resource.

In some examples of the methods and network entities described herein, receiving the one or more uplink resource allocation requests may include operations, features, means, or instructions for receiving a single uplink resource allocation request in accordance with the first satisfaction of the first condition and the second satisfaction of the second condition occurring within the threshold duration of each other, where the single uplink resource allocation request includes an indication, via one or more bits of the single uplink resource allocation request, that the first satisfaction of the first condition and the second satisfaction of the second condition occurred within the threshold duration of each other.

In some examples of the methods and network entities described herein, transmitting the one or more resource grants may include operations, features, means, or instructions for transmitting a single resource grant in accordance with the indication, where the single resource grant allocates the set of uplink resources, and where the network entity receives the uplink beam report and the downlink beam report as a joint uplink and downlink beam report.

In some examples of the methods and network entities described herein, a bitword associated with the one or more bits indicates whether a requested resource may be associated with an uplink-only beam report, a downlink-only beam report, or a joint uplink and downlink beam report.

In some examples of the methods and network entities described herein, the uplink beam report includes first information indicative of one or more uplink metrics associated with one or more first reference signals and the downlink beam report includes second information indicative of one or more downlink metrics associated with one or more second reference signals.

In some examples of the methods and network entities described herein, the threshold duration may be defined by a difference between a first time at which the first satisfaction of the first condition or the second satisfaction of the second condition occurs and a second time at which the UE transmits the one or more uplink resource allocation requests, or may be defined by a timer that restricts resource allocation requests associated with UE-initiated uplink beam reports or UE-initiated downlink beam reports.

A method for wireless communications by a network entity is described. The method may include receiving a first uplink resource allocation request associated with a first beam report in accordance with a first satisfaction of a first condition associated with a first type of UE-initiated beam reporting at a UE, transmitting a first resource grant associated with the first beam report in accordance with receiving the first uplink resource allocation request, and receiving, via at least a first set of uplink resources allocated by the first resource grant, the first beam report, a second beam report, or both in accordance with a second satisfaction, prior to transmitting the first resource grant, of a second condition associated with a second type of UE-initiated beam reporting at the UE.

A network entity for wireless communications is described. The network entity may include one or more memories storing processor executable code, and one or more processors coupled with the one or more memories. The one or more processors may individually or collectively be operable to execute the code to cause the network entity to receive a first uplink resource allocation request associated with a first beam report in accordance with a first satisfaction of a first condition associated with a first type of UE-initiated beam reporting at a UE, transmit a first resource grant associated with the first beam report in accordance with receiving the first uplink resource allocation request, and receive, via at least a first set of uplink resources allocated by the first resource grant, the first beam report, a second beam report, or both in accordance with a second satisfaction, prior to transmitting the first resource grant, of a second condition associated with a second type of UE-initiated beam reporting at the UE.

Some examples of the methods and network entities described herein may further include operations, features, means, or instructions for receiving a second uplink resource allocation request associated with the second beam report in accordance with the second satisfaction of the second condition associated with the second type of UE-initiated beam reporting at the UE and transmitting a second resource grant associated with the second beam report in accordance with receiving the second uplink resource allocation request.

In some examples of the methods and network entities described herein, receiving the first beam report, the second beam report, or both may include operations, features, means, or instructions for receiving the first beam report via the first set of uplink resources allocated by the first resource grant and receiving the second beam report via a second set of uplink resources allocated by the second resource grant.

Some examples of the methods and network entities described herein may further include operations, features, means, or instructions for demultiplexing a second uplink resource allocation request associated with the second beam report from the first beam report and transmitting a second resource grant associated with the second beam report in accordance with demultiplexing the second uplink resource allocation request from the first beam report.

In some examples of the methods and network entities described herein, receiving the first beam report, the second beam report, or both may include operations, features, means, or instructions for receiving the first beam report and the second uplink resource allocation request via the first set of uplink resources allocated by the first resource grant and receiving the second beam report via a second set of uplink resources allocated by the second resource grant.

Some examples of the methods and network entities described herein may further include operations, features, means, or instructions for demultiplexing the first beam report and the second beam report from the first set of uplink resources allocated by the first resource grant, where uplink resources, from the first set of uplink resources, may be allocated to the first beam report and the second beam report in accordance with a relative priority between the first beam report and the second beam report.

In some examples of the methods and network entities described herein, resource allocation to the first beam report may be prioritized in accordance with the first beam report having a higher priority than the second beam report.

In some examples of the methods and network entities described herein, the network entity receives the first beam report and the second beam report via the first set of uplink resources allocated by the first resource grant as a joint beam report.

In some examples of the methods and network entities described herein, the first beam report may be a downlink beam report, and the first type of UE-initiated beam reporting may be UE-initiated downlink beam reporting and the second beam report may be an uplink beam report, and the second type of UE-initiated beam reporting may be UE-initiated uplink beam reporting.

In some examples of the methods and network entities described herein, the first beam report may be an uplink beam report, and the first type of UE-initiated beam reporting may be UE-initiated uplink beam reporting and the second beam report may be a downlink beam report, and the second type of UE-initiated beam reporting may be UE-initiated downlink beam reporting.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports multiple resource allocation requests in user equipment (UE)-initiated beam reporting in accordance with one or more aspects of the present disclosure.

FIG. 2 shows an example of a signaling diagram that supports multiple resource allocation requests in UE-initiated beam reporting in accordance with one or more aspects of the present disclosure.

FIG. 3 shows an example of a signaling exchange that supports multiple resource allocation requests in UE-initiated beam reporting in accordance with one or more aspects of the present disclosure.

FIGS. 4-7 show examples of process flows that support multiple resource allocation requests in UE-initiated beam reporting in accordance with one or more aspects of the present disclosure.

FIGS. 8 and 9 show block diagrams of devices that support multiple resource allocation requests in UE-initiated beam reporting in accordance with one or more aspects of the present disclosure.

FIG. 10 shows a block diagram of a communications manager that supports multiple resource allocation requests in UE-initiated beam reporting in accordance with one or more aspects of the present disclosure.

FIG. 11 shows a diagram of a system including a device that supports multiple resource allocation requests in UE-initiated beam reporting in accordance with one or more aspects of the present disclosure.

FIGS. 12 and 13 show block diagrams of devices that support multiple resource allocation requests in UE-initiated beam reporting in accordance with one or more aspects of the present disclosure.

FIG. 14 shows a block diagram of a communications manager that supports multiple resource allocation requests in UE-initiated beam reporting in accordance with one or more aspects of the present disclosure.

FIG. 15 shows a diagram of a system including a device that supports multiple resource allocation requests in UE-initiated beam reporting in accordance with one or more aspects of the present disclosure.

FIGS. 16-21 show flowcharts illustrating methods that support multiple resource allocation requests in UE-initiated beam reporting in accordance with one or more aspects of the present disclosure.

### DETAILED DESCRIPTION

In some wireless communications systems, a user equipment (UE) and a network entity may support directional communication according to which the UE and the network entity may communicate (such as transmit or receive) using one or more directional beams. Such directional beams, which may be understood as configurations associated with directional communication and defined by transmission configuration indicator (TCI) states, may include one or more downlink beams and one or more uplink beams. For example, the network entity may transmit signaling to the UE using one or more downlink beams and the UE may transmit signaling to the network entity using one or more uplink beams. In some systems, a downlink beam and an uplink beam may be associated with a downlink reference signal, such as via a configured or activated TCI state. In such systems, the network entity and the UE may use a first downlink beam and a first uplink beam, respectively, for communication in a first direction associated with a first downlink reference signal and may use a second downlink beam and a second uplink beam, respectively, for communication in a second direction associated with a second downlink reference signal.

In some scenarios, a signal quality provided by a downlink beam may be relatively similar to a signal quality provided by a corresponding uplink beam (such as an uplink beam associated with a same downlink reference signal as the downlink beam). In such scenarios of uplink and downlink reciprocity, the UE and the network entity may use downlink-only beam reporting to support reliable communication (as metrics associated with the downlink beam may be relatively similar to metrics associated with the corresponding uplink beam). In some other scenarios, a signal quality provided by a downlink beam and a signal quality provided by a corresponding uplink beam may deviate from each other. Such scenarios may arise for various reasons, such as an uplink power backoff at the UE or a dynamic uplink beam pattern change at the UE. In such scenarios, the UE and the network entity may be unable to use downlink-only beam reporting to support reliable communication and may supplement downlink beam reporting with uplink beam reporting. Uplink beam reporting may involve additional signaling exchanges between the UE and the network entity and, because uplink beam reports may be relevant due to UE-side operations, may be UE-initiated (such as in accordance with a satisfaction of a condition at the UE). Some systems may lack mechanisms according to which UE-initiated uplink beam reporting can be controlled, which may result in uncontrolled signaling overhead. Thus, some systems may benefit from additional signaling mechanisms associated with UE-initiated uplink beam reporting.

Various aspects relate generally to one or more signaling mechanisms according to which a UE may transmit or otherwise manage multiple resource allocation requests that are triggered in UE-initiated beam reporting. Some aspects more specifically relate to a timer according to which a UE may restrict a frequency at which the UE transmits resource allocation requests associated with UE-initiated uplink beam reporting. For example, the UE may transmit a resource allocation request associated with an uplink beam report and may monitor for a resource grant within a time period indicated by a timer prior to transmitting another resource allocation request associated with the uplink beam report (or associated with UE-initiated uplink beam reporting more generally). Such a timer may restrict uplink resource allocation requests associated with UE-initiated uplink beam reports, as the UE may be unable to transmit another uplink resource allocation request until a resource grant is received or until an expiration of the timer (whichever occurs earlier). In some examples, the UE may receive an (explicit) indication of the timer from the network entity via control signaling. Additionally, or alternatively, the UE may receive an indication of a communication parameter (such as a subcarrier spacing (SCS)) from the network entity via control signaling and determine the timer based on the communication parameter.

Such aspects of the subject matter described in this disclosure can be implemented to realize one or more of the following potential advantages. In some examples, by supporting the timer that restricts uplink resource allocation requests associated with UE-initiated uplink beam reports, the UE may avoid consuming too many system resources, which may reduce signaling overhead and provide more resources for other devices within the system. Further, and also by supporting the timer that restricts uplink resource allocation requests associated with UE-initiated uplink beam reports, the UE and the network entity may achieve a target balance between communication reliability and signaling overhead, which may increase data rates and system capacity and facilitate higher spectrum efficiency, among other benefits.

Some additional, or alternative, aspects more specifically relate to one or more mechanisms according to which a UE may operate in scenarios in which conditions associated with both UE-initiated uplink beam reporting and UE-initiated downlink beam reporting are satisfied within a threshold duration of each other (such as before the UE transmits a resource allocation request associated with either beam reporting). In some examples, the UE may transmit separate resource allocation requests (such as a first resource allocation request associated with an uplink beam report and a second resource allocation request associated with a downlink beam report) independent of the times at which the conditions are satisfied. In some other examples, the UE may transmit a single resource allocation request and may use a corresponding resource grant for one of an uplink beam report or a downlink beam report in accordance with an autonomous UE decision or a relative priority between the uplink beam report and the downlink beam report. Additionally, or alternatively, the UE may transmit a single resource allocation request via a physical uplink control channel (PUCCH) resource that is associated with simultaneous uplink and downlink beam reporting. Additionally, or alternatively, the UE may transmit a single resource allocation request and may include, within the single resource allocation request, an indication that both uplink beam reporting and downlink beam reporting are triggered at the UE.

Such aspects of the subject matter described in this disclosure can be implemented to realize one or more of the following potential advantages. In some examples, by supporting mechanisms according to which the UE may operate in scenarios in which conditions associated with both UE-initiated uplink beam reporting and UE-initiated downlink beam reporting are satisfied within the threshold duration of each other, the UE and the network entity may reliably manage such scenarios without ambiguity or with a suitable prioritization between uplink and downlink beam reports. By reliably managing such scenarios without ambiguity or with a suitable prioritization between uplink and downlink beam reports, the UE and the network entity may achieve more reliable communication and higher data rates in accordance with facilitating timely and relevant beam report updates. Further, in accordance with the disclosed mechanisms, the UE and the network entity may achieve higher spectrum efficiency, among other benefits, in accordance with enabling a single resource allocation request to be associated with either or both of UE-initiated uplink beam reporting and UE-initiated downlink beam reporting.

Some additional, or alternative, aspects more specifically relate to one or more mechanisms according to which a UE may operate in scenarios in which the UE transmits a first resource allocation request associated with a first type of UE-initiated beam reporting and detects, prior to receiving a corresponding resource grant, that a condition associated with a second type of UE-initiated beam reporting is also satisfied. In some examples, the UE may transmit a (separate or standalone) second resource allocation request associated with the second type of UE-initiated beam reporting independent of the timing of the resource grant provided by the network entity. In some other examples, the UE may multiplex the second resource allocation request associated with the second type of UE-initiated beam reporting with a first beam report associated with the first type of UE-initiated beam reporting. In some other examples, the UE may refrain from transmitting the second resource allocation request associated with the second type of UE-initiated beam reporting and may attempt to multiplex a second beam report associated with the second type of UE-initiated beam reporting with the first beam report (depending on a size of the resource grant and relative priorities between the first and second types of UE-initiated beam reporting). Additionally, or alternatively, the UE may transmit the first beam report associated with the first type of UE-initiated beam reporting and the second beam report associated with the second type of UE-initiated beam reporting as a joint downlink and uplink beam report.

Such aspects of the subject matter described in this disclosure can be implemented to realize one or more of the following potential advantages. In some examples, by supporting mechanisms according to which the UE may operate in scenarios in which the UE transmits a first resource allocation request associated with a first type of UE-initiated beam reporting and detects, prior to receiving a corresponding resource grant, that a condition associated with a second type of UE-initiated beam reporting is also satisfied, the UE and the network entity may reliably manage such scenarios without ambiguity or with a suitable prioritization between uplink and downlink beam reports. By reliably managing such scenarios without ambiguity or with a suitable prioritization between uplink and downlink beam reports, the UE and the network entity may achieve more reliable communication and higher data rates in accordance with facilitating timely and relevant beam report updates. Further, in accordance with the disclosed mechanisms, the UE and the network entity may achieve higher spectrum efficiency, among other benefits, in accordance with selectively multiplexing signaling or selectively (de)prioritizing one or more types of UE-initiated beam reporting.

Aspects of the disclosure are initially described in the context of wireless communications systems. Additionally, aspects of the disclosure are illustrated by and described with reference to a signaling diagram, a signaling exchange, and process flows. Aspects of the disclosure are further illustrated by and described with reference to apparatus diagrams, system diagrams, and flowcharts that relate to multiple resource allocation requests in UE-initiated beam reporting.

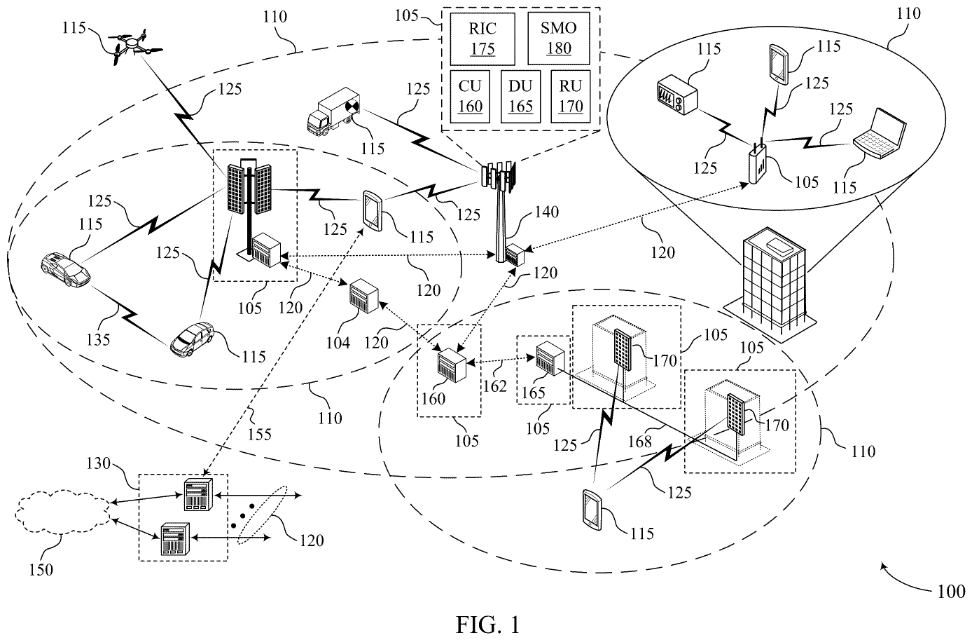

FIG. 1 shows an example of a wireless communications system 100 that supports multiple resource allocation requests in UE-initiated beam reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack, and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack, and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support multiple resource allocation requests in UE-initiated beam reporting as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred—the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A UE 115 and a network entity 105 may support one or more signaling mechanisms according to which the UE 115 may transmit or otherwise manage multiple resource allocation requests in UE-initiated beam reporting. Such UE-initiated beam reporting may include UE-initiated uplink beam reporting, UE-initiated downlink beam reporting, or any combination thereof. In some aspects, the UE 115 and the network entity 105 may support a timer according to which the UE 115 may restrict a frequency at which the UE 115 transmits resource allocation requests in UE-initiated uplink beam reporting. Additionally, or alternatively, the UE 115 and the network entity 105 may support one or more mechanisms according to which the UE 115 operates in scenarios in which conditions associated with both UE-initiated uplink beam reporting and UE-initiated downlink beam reporting are satisfied within a threshold duration of each other (such as before the UE 115 transmits a resource allocation request associated with either beam reporting). Additionally, or alternatively, the UE 115 and the network entity 105 may support one or more mechanisms according to which the UE 115 operates in scenarios in which the UE 115 transmits a first resource allocation request associated with a first type of UE-initiated beam reporting and detects, prior to receiving a corresponding resource grant, that a condition associated with a second type of UE-initiated beam reporting is also satisfied.

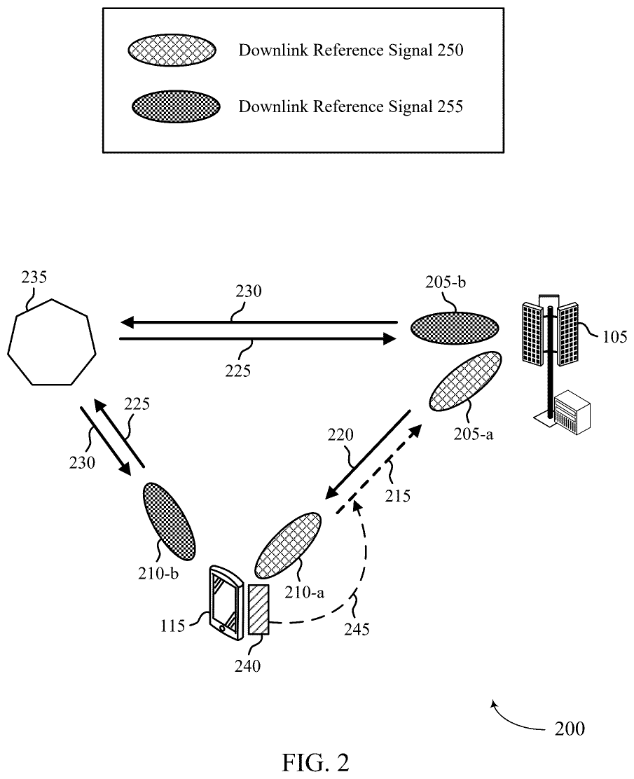

FIG. 2 shows an example of a signaling diagram 200 that supports multiple resource allocation requests in UE-initiated beam reporting in accordance with one or more aspects of the present disclosure. The signaling diagram 200 may implement or be implemented to realize one or more aspects of the wireless communications system 100. For example, the signaling diagram 200 illustrates communication between a UE 115 and a network entity 105, which may be examples of corresponding devices illustrated and described herein, including by and with reference to FIG. 1.

The UE 115 and the network entity 105 may support beam reporting. In some systems, the beam reporting supported by the UE 115 and the network entity 105 may include downlink beam reporting, such that beam/cell reports may include downlink metrics and may exclude uplink metrics. For example, a downlink beam report may include downlink metrics such as a downlink reference signal receive power (RSRP), a downlink SNR, or a downlink signal-to-interference-plus-noise ratio (SINR), among other examples. In such systems, a selected beam or cell may be relatively less suitable for uplink performance as compared to one or more other beams or cells. For example, and as illustrated by the signaling diagram 200, the UE 115 may report information (such as metrics, such as signal quality metrics) associated with two downlink reference signals including a downlink reference signal 250 and a downlink reference signal 255. The downlink reference signal 250 and the downlink reference signal 255 may be examples of two CSI-RSs (each associated with a different CSI-RS beam) that are quasi-collocated with a same synchronization signal block (SSB) (a same SSB beam) or may be examples of two different SSBs (each associated with a different SSB beam).

The downlink reference signal 250, which the network entity 105 may transmit using a downlink beam 205-a and which the UE 115 may receive using an uplink beam 210-a via a downlink signal path 220, may be associated with a first downlink metric (such as a first downlink RSRP). The downlink reference signal 250 may be associated with an uplink signal path 215, which may be associated with a first uplink metric (such as a first uplink RSRP). The downlink reference signal 255, which the network entity 105 may transmit using a downlink beam 205-b and which the UE 115 may receive using an uplink beam 210-b via a downlink path 230, may be associated with a second downlink metric (such as a second downlink RSRP). The downlink reference signal 255 may be associated with an uplink signal path 225, which may be associated with a second uplink metric (such as a second uplink RSRP). In the example deployment scenario illustrated by the signaling diagram 200, the downlink path 230 and the uplink signal path 225 may involve a reflection off a surface 235, which may be a reconfigurable intelligent surface (RIS), an object, a relay node, or any other node within a wireless communications system.

In some scenarios, the first downlink metric associated with the downlink reference signal 250 may be greater than the second downlink metric associated with the downlink reference signal 255. In examples in which the network entity 105 selects a beam for directional communication using downlink-only metrics, the network entity 105 may accordingly select directional beams associated with the downlink reference signal 250 for communication between the UE 115 and the network entity 105. In some examples, however, the first uplink metric associated with the downlink reference signal 250 may be less than the second uplink metric associated with the downlink reference signal 255. For example, the UE 115 may experience a blockage 240 that results in an uplink power backoff 245 for uplink signaling sent in a direction associated with the uplink beam 210-a. Such a blockage 240 may, for example, be a user's hand that results in the uplink power backoff 245 in accordance with a maximum permissible exposure (MPE) constraint at the UE 115. Thus, a selection of directional beams associated with the downlink reference signal 250 (which the network entity 105 may perform without uplink metrics being reported from the UE 115) may result in relatively worse uplink performance as compared to a selection of directional beams associated with the downlink reference signal 255.

The UE 115 may initiate downlink beam reporting in accordance with a satisfaction of a condition, such as in accordance with a trigger-event detection associated with beam reporting. Such beam reporting may be understood as UE-initiated/event-driven beam reporting. The condition associated with UE-initiated beam reporting may be associated with one or more quality metrics, one or more events, one or more thresholds, or any combination thereof.

For example, the UE 115 may initiate downlink beam reporting in accordance with a quality of a current beam being worse than a threshold (such that an SNR or an RSRP is less than a threshold SNR or a threshold RSRP, respectively). By way of further example, the UE 115 may initiate downlink beam reporting in accordance with a quality of at least one new beam, such as measured by RSRP (such as L1-RSRP), becoming a threshold value better than a current beam. By way of further example, the UE 115 may initiate downlink beam reporting in accordance with a quality of a new beam becoming better than a threshold (such that an SNR or an RSRP is greater than a threshold SNR or a threshold RSRP, respectively). By way of further example, the UE 115 may initiate downlink beam reporting in accordance with a quality of a current beam being worse than a first threshold and a quality of at least one new beam being greater than a second threshold.

In some systems, the UE 115 and the network entity 105 may extend beam reporting to include both downlink beam reporting and uplink beam reporting. In such systems, to select beams in downlink and uplink, the UE 115 may report uplink metrics (such as uplink beam metrics) in an uplink-only beam report or in a joint downlink and uplink beam report. For example, in a joint downlink and uplink beam report, the UE 115 may report a top (such as a best, such as those associated with relatively highest signal quality metrics) N downlink and M uplink beams, respectively, based on which the network entity 105 may select one or more downlink beams and one or more uplink beams. For example, in accordance with uplink beam reporting, the network entity 105 may select directional beams associated with the downlink reference signal 250 for downlink communication and may select directional beams associated with the downlink reference signal 255 for uplink communication. In some examples, to reduce overhead, the UE 115 may report N beams with both downlink and uplink metrics reported per beam. Uplink metrics may include an uplink RSRP, an uplink SNR, or an uplink SINR, among other examples. In some systems, the UE 115 and the network entity 105 may support uplink beam reporting in cell reporting for lower layer triggered mobility, via which the UE 115 may report both downlink and uplink metrics (such as both downlink and uplink beam metrics) per reported candidate cell. An example of a beam report including both downlink and uplink metrics is illustrated by Table 1, shown below.

TABLE 1
Beam Report Including Downlink and Uplink Metrics

| | |
|---|---|
| Top 4 Downlink Beams | Top 4 Uplink Beams |

| | | | |
|---|---|---|---|
| First Downlink | Downlink | First Uplink | Uplink |
| Reference Signal | RSRP #1 | Reference Signal | RSRP #1 |
| Second Downlink | Downlink | Second Uplink | Uplink |
| Reference Signal | RSRP #2 | Reference Signal | RSRP #2 |
| Third Downlink | Downlink | Third Uplink | Uplink |
| Reference Signal | RSRP #3 | Reference Signal | RSRP #3 |
| Fourth Downlink | Downlink | Fourth Uplink | Uplink |
| Reference Signal | RSRP #4 | Reference Signal | RSRP #4 |

The UE 115 may transmit a UE-initiated beam report via a set of uplink resources allocated by the network entity 105. To receive a resource grant from the network entity 105, the UE 115 may transmit a resource allocation request to the network entity 105 in accordance with a satisfaction of a condition associated with the UE-initiated beam reporting. UE-initiated beam reporting may include UE-initiated uplink beam reporting and UE-initiated downlink beam reporting and, in some examples, UE-initiated uplink beam reporting may be associated with a first set of one or more triggering conditions and UE-initiated downlink beam reporting may be associated with a second set of one or more triggering conditions. The first set of triggering conditions may be the same as, partially overlapping with, or completely different than the second set of triggering conditions.

In systems in which the UE 115 supports both UE-initiated uplink beam reporting and UE-initiated downlink beam reporting, various scenarios may arise in which the UE 115 may be triggered to transmit multiple resource allocation requests. Such multiple resource allocation requests may be triggered by a failure to successfully receive a requested resource grant or by multiple conditions being satisfied simultaneously or approximately simultaneously, among other examples. In some aspects, the UE 115 and the network entity 105 may support one or more signaling mechanisms according to which the UE 115 may transmit or otherwise manage multiple resource allocation requests in UE-initiated beam reporting, with such UE-initiated beam reporting may including UE-initiated uplink beam reporting, UE-initiated downlink beam reporting, or any combination thereof.

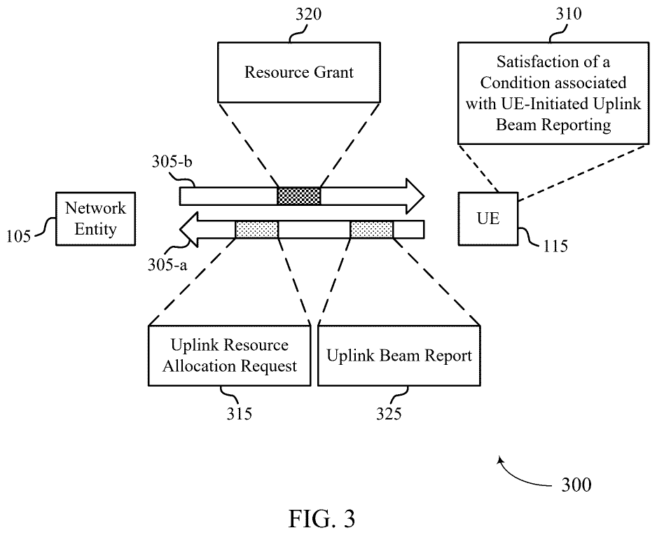

FIG. 3 shows an example of a signaling exchange 300 that supports multiple resource allocation requests in UE-initiated beam reporting in accordance with one or more aspects of the present disclosure. The signaling exchange 300 may implement or be implemented to realize one or more aspects of the wireless communications system 100 or the signaling diagram 200. For example, the signaling exchange 300 illustrates communication between a UE 115 and a network entity 105, which may be examples of corresponding devices illustrated and described herein, including by and with reference to FIGS. 1 and 2.

The signaling exchange 300 illustrates an example exchange of wireless communications between the UE 115 and the network entity 105 according to which the UE 115 may obtain resources for a UE-initiated beam report. For example, the UE 115 may transmit, to the network entity 105 via an uplink 305-a, an uplink resource allocation request 315 associated with an uplink beam report 325 in accordance with a satisfaction 310 of a condition associated with UE-initiated uplink beam reporting. In accordance with transmitting the uplink resource allocation request 315, the UE 115 may monitor for and receive a resource grant 320 via a downlink 305-b. The resource grant 320 may indicate (such as provide or allocate) a set of uplink resources via which the UE 115 may transmit the uplink beam report 325.

The satisfaction 310 of the condition associated with UE-initiated uplink beam reporting may trigger dynamic uplink reporting to the network entity 105 due to one or more changes or decisions at the UE 115. Such changes or decisions at the UE 115 may include any change or decision at the UE 115 that impacts an uplink beam and a downlink beam unequally (such as changes that impact an uplink beam and do not impact a downlink beam, among other examples). For example, such changes or decisions at the UE 115 may include the UE 115 changing an uplink beam pattern in accordance with using fewer antenna elements per uplink port. By way of further example, such changes or decisions at the UE 115 may include the UE 115 dynamically updating an uplink beam pattern associated with a TCI state in accordance with a device management decision (such as an autonomous UE decision). By way of further example, such changes or decisions at the UE 115 may include the UE 115 applying an uplink power backoff that is non-negligible but that does not trigger an MPE report from the UE 115 to the network entity 105. The condition associated with UE-initiated uplink beam reporting may be satisfied in accordance with any one or more of such changes or decisions at the UE 115.

The UE 115 and the network entity 105 may support, in addition to dynamic uplink beam reports (such as the uplink beam report 325), periodic or semi-persistent uplink beam reports. For example, the network entity 105 may configure (via, for example, RRC signaling) the UE 115 with one or more sets of periodically or semi-persistently occurring uplink resources and the UE 115 may use such one or more sets of uplink resources to periodically or semi-persistently transmit one or more uplink beam reports. The UE 115 may periodically or semi-persistently transmit one or more uplink beam reports during time periods within which the one or more sets of periodically or semi-persistently occurring uplink resources are configured or activated.

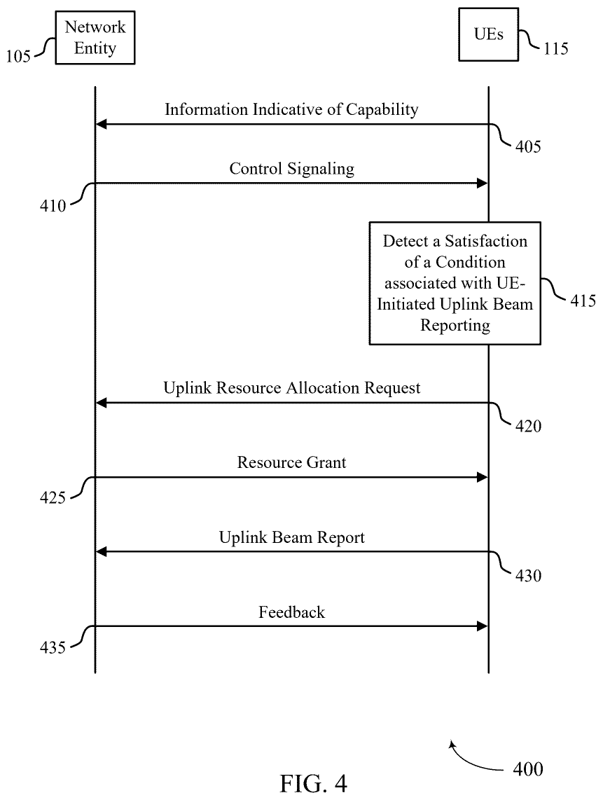

FIG. 4 shows an example of a process flow 400 that supports multiple resource allocation requests in UE-initiated beam reporting in accordance with one or more aspects of the present disclosure. The process flow 400 may implement or be implemented to realize one or more aspects of the wireless communications system 100, the signaling diagram 200, or the signaling exchange 300. For example, the process flow 400 illustrates communication between a UE 115 and a network entity 105, which may be examples of corresponding devices illustrated and described herein, including by and with reference to FIGS. 1-3.

In the following description of the process flow 400, the operations may be performed (such as reported or provided) in a different order than the order shown, or the operations performed by the example devices may be performed in different orders or at different times. Some operations also may be left out of the process flow 400, or other operations may be added to the process flow 400. Further, although some operations or signaling may be shown to occur at different times for discussion purposes, these operations may actually occur at the same time.

At 405, the UE 115 may transmit, to the network entity 105, information indicative of a capability of the UE 115. The UE 115 may transmit the information indicative of the capability of the UE 115 via uplink control information (UCI), one or more MAC control elements (MAC-CEs), RRC signaling (such as via UE assistance signaling or information elements), or any combination thereof. The information may indicate whether the UE 115 is capable of UE-initiated downlink beam reporting, whether the UE 115 is capable of UE-initiated uplink beam reporting, or one or more conditions associated with UE-initiated beam reporting that trigger downlink or uplink beam reports. Additionally, or alternatively, the information may indicate whether the UE 115 is capable of supporting one or more of the mechanisms disclosed herein, including whether the UE 115 is capable of supporting a timer that restricts UE-initiated uplink/downlink beam reporting or how the UE 115 may operate in scenarios in which multiple conditions are satisfied simultaneously or approximately simultaneously, among other aspects.

At 410, the UE 115 may receive control signaling from the network entity 105. The control signaling may include downlink control information (DCI), one or more MAC-CEs, RRC signaling, or any combination thereof. The control signaling may be understood as configuration signaling. In some examples, the UE 115 and the network entity 105 may perform the operations at 405 and at 410 as part of a configuration and capability signaling exchange. The control signaling may indicate (such as configure) one or more PUCCH resources associated with UE-initiated beam reporting or one or more conditions that are expected to trigger UE-initiated beam reporting, among other examples.

At 415, the UE 115 may detect a satisfaction of a condition associated with UE-initiated uplink beam reporting. Such a satisfaction of a condition associated with UE-initiated uplink beam reporting may include an occurrence of one or more changes or decisions at the UE 115 that impact one or more uplink beams and one or more downlink beams unequally, as described in more detail with reference to FIG. 3.

At 420, the UE 115 may transmit an uplink resource allocation request to the network entity 105. The UE 115 may transmit the uplink resource allocation request via a PUCCH resource, such as via UCI. The uplink resource allocation request may be understood as indication/request signaling associated with the UE-initiated uplink beam reporting.

At 425, the UE 115 may receive a resource grant (such as an uplink grant) from the network entity 105. The UE 115 may receive the resource grant via a physical downlink control channel (PDCCH), such as via DCI. The resource grant may be understood as a response and grant via which the UE 115 may send an uplink beam report (such as an updated uplink beam report).

At 430, the UE 115 may transmit the uplink beam report. The UE 115 may transmit the uplink beam report via a set of uplink resources allocated by the resource grant, which may include physical uplink shared channel (PUSCH) resources. In some examples, the UE 115 may transmit the uplink beam report via one or more MAC-CEs. The uplink beam report may be an uplink-only beam report or a joint downlink and uplink beam report. The uplink beam report may include one or more uplink metrics, such as one or more of an uplink RSRP, an uplink SNR, or an uplink SINR. The UE 115 may determine such uplink metrics by measuring one or more downlink reference signals or by predicting the metrics in accordance with one or more changes or decisions at the UE 115.

At 435, the UE 115 may receive feedback from the network entity 105 associated with the uplink beam report. In examples in which the network entity 105 successfully receives the uplink beam report, the feedback may include a positive acknowledgment (ACK). In examples in which the network entity 105 unsuccessfully receives the uplink beam report, the feedback may include a negative acknowledgment (NACK).

In some aspects, the UE 115 may transmit or otherwise manage multiple resource allocation requests. Such multiple resource allocation requests may be triggered by a failure to successfully receive a requested resource grant or by multiple conditions being satisfied simultaneously or approximately simultaneously, among other examples. For example, the UE 115 and the network entity 105 may support one or more mechanisms according to which the UE 115 may transmit or otherwise manage multiple resource allocation requests in UE-initiated beam reporting.

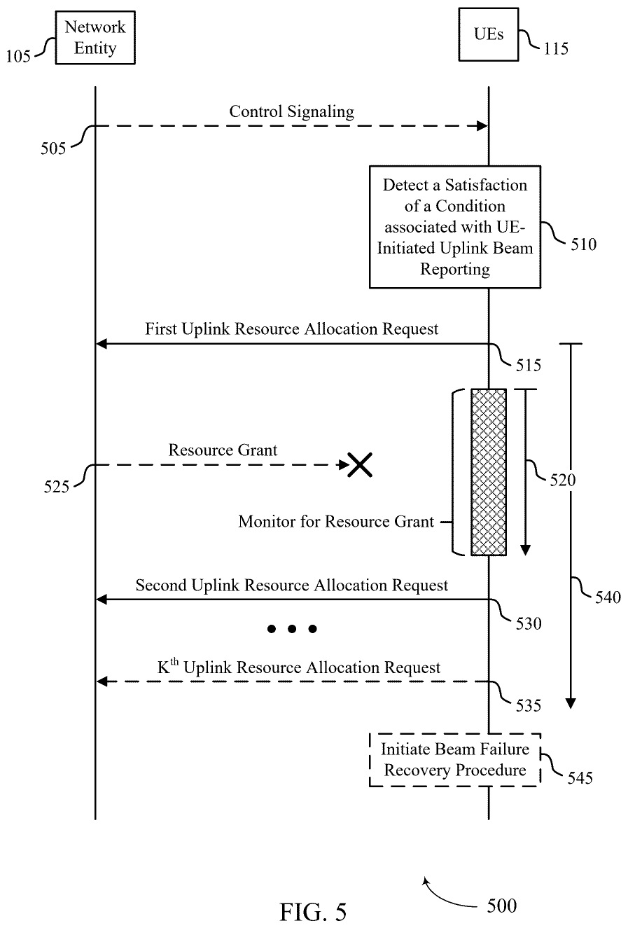

FIG. 5 shows an example of a process flow 500 that supports multiple resource allocation requests in UE-initiated beam reporting in accordance with one or more aspects of the present disclosure. The process flow 500 may implement or be implemented to realize one or more aspects of the wireless communications system 100, the signaling diagram 200, the signaling exchange 300, or the process flow 400. For example, the process flow 500 illustrates communication between a UE 115 and a network entity 105, which may be examples of corresponding devices illustrated and described herein, including by and with reference to FIGS. 1-4.

In the following description of the process flow 500, the operations may be performed (such as reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time.

At 505, the UE 115 may receive control signaling from the network entity 105. The control signaling may include DCI, one or more MAC-CEs, RRC signaling, or any combination thereof. The control signaling may be understood as configuration signaling. In some examples, the control signaling may include an indication of a duration or length of a timer that restricts uplink resource allocation requests associated with UE-initiated uplink beam reporting. In such examples, the timer that restricts uplink resource allocation requests associated with UE-initiated uplink beam reporting may be an RRC configured timer (with the control signaling indicating a value (such as a duration or length) of the timer, potentially from multiple available or possible values). Additionally, or alternatively, the control signaling may include an indication of one or more communication parameters (such as an SCS), which may relate to the timer that restricts uplink resource allocation requests associated with UE-initiated uplink beam reporting. For example, the UE 115 may determine a duration or length of the timer in accordance with the one or more communication parameters (such as based on an SCS). Additionally, or alternatively, a duration or length of the timer may be defined to be commonly applicable to UEs 115 within a wireless communications system, such as in accordance with a network specification.

At 510, the UE 115 may detect a satisfaction associated with a condition associated with UE-initiated uplink beam reporting. Such a satisfaction of a condition associated with UE-initiated uplink beam reporting may include an occurrence of one or more changes or decisions at the UE 115 that impact one or more uplink beams and one or more downlink beams unequally, as described in more detail with reference to FIG. 3.

At 515, the UE 115 may transmit a first uplink resource allocation request associated with an uplink beam report in accordance with the satisfaction of the condition associated with UE-initiated uplink beam reporting. The first uplink resource allocation request may be a request for a UE-initiated uplink beam report update. In accordance with transmitting the first uplink resource allocation request, the UE 115 may monitor a PDCCH for a response from the network entity 105 within a time period 520 indicated by the timer that restricts uplink resource allocation requests associated with UE-initiated uplink beam reporting. The timer may have a length or duration of N, with N being RRC configured via a timer (such as the timer that restricts uplink resource allocation requests associated with UE-initiated uplink beam reporting), with N being determined by the UE 115 based on a communication parameter (such as SCS), or with N being defined by a network specification.

By way of example, the time period 520 may be denoted by N such that, in examples in which the UE 115 transmits the first uplink resource allocation request via a PUCCH in a slot k, the UE 115 may monitor DCI via PDCCH until slot k+N. Alternatively, the UE 115 may begin monitoring the PDCCH at a slot offset from slot k, such that the UE 115 may monitor DCI via the PDCCH from a slot k+m until slot k+m+N, where m is the offset.

In examples in which the network entity 105 receives the first uplink resource allocation request, at 525, the network entity 105 may transmit a resource grant associated with the uplink beam report (such as to provide uplink resources for the uplink beam report). In some scenarios, the UE 115 may fail to receive the resource grant. In examples in which the network entity 105 fails to receive the first uplink resource allocation request, the network entity 105 may not transmit the resource grant at 525. Thus, in some examples, the UE 115 may monitor the PDCCH within the time period 520 indicated by the timer and the timer may expire prior to a reception of the resource grant.

At 530, the UE 115 may transmit a second uplink resource allocation request associated with the uplink beam report. The UE 115 may transmit the second uplink resource allocation request in accordance with an absence of the resource grant and the expiration of the timer that restricts uplink resource allocation requests associated with UE-initiated uplink beam reporting. In other words, the UE 115 may not transmit another uplink resource allocation request (such as another indication for an uplink beam report update) within the time period 520 during which the UE 115 monitors for a response from the network entity 105 to a prior uplink resource allocation request. In some aspects, such behavior of the UE 115 may be in accordance with a signaled or network-defined rule.

In some examples, the UE 115 may continue transmitting uplink resource allocation requests associated with the uplink beam report in accordance with a continued absence of (such as a continued failure to receive) the resource grant associated the uplink beam report. In some examples, as part of continuing to transmit uplink resource allocation requests associated with the uplink beam report, the UE 115 may apply (such as perform or employ) a power ramp such that a transmit power used by the UE 115 to transmit the uplink resource allocation requests increases over time (such as from one uplink resource allocation request to a next uplink resource allocation request).

At 535, the UE 115 may transmit a Kth uplink resource allocation request. In some aspects, K may be a threshold quantity of uplink resource allocation requests. In such aspects, the UE 115 may continue retransmitting uplink resource allocation requests up to K times. Additionally, or alternatively, the Kth uplink resource allocation request may be a final uplink resource allocation request prior to an expiration of a threshold time period 540 from the first uplink resource allocation request. In such examples, the UE 115 may continue retransmitting uplink resource allocation requests until the threshold time period 540 from the first uplink resource allocation request (such as the initial transmission) is exceeded. The threshold time period 540 may be associated with a timer, which may be an RRC configured timer, a timer based on one or more communication parameters, a timer based on a capability of the UE 115, or a timer that is defined by a network specification, among other examples. Additionally, or alternatively, the network entity 105 may indicate a value of K to the UE 115 via signaling (such as via RRC signaling, such that the value of K may be RRC configured), the value of K may be based on a capability of the UE 115, the value of K may be based on one or more communication parameters, the value of K may be defined by a network specification, or any combination thereof.

At 545, if no response associated with the uplink resource allocation requests (such as the UE-initiated uplink beam report update requests) transmitted by the UE 115 is received by the Kth uplink resource allocation request, the UE 115 may initiate a beam failure recovery procedure. Additionally, or alternatively, the UE 115 may apply (such as perform or employ) a power ramp such that a transmit power used by the UE 115 to transmit subsequent uplink resource allocation requests (such as a (K+1)th uplink resource allocation request) is greater than a transmit power that the UE 115 used to transmit the initial K uplink resource allocation requests.

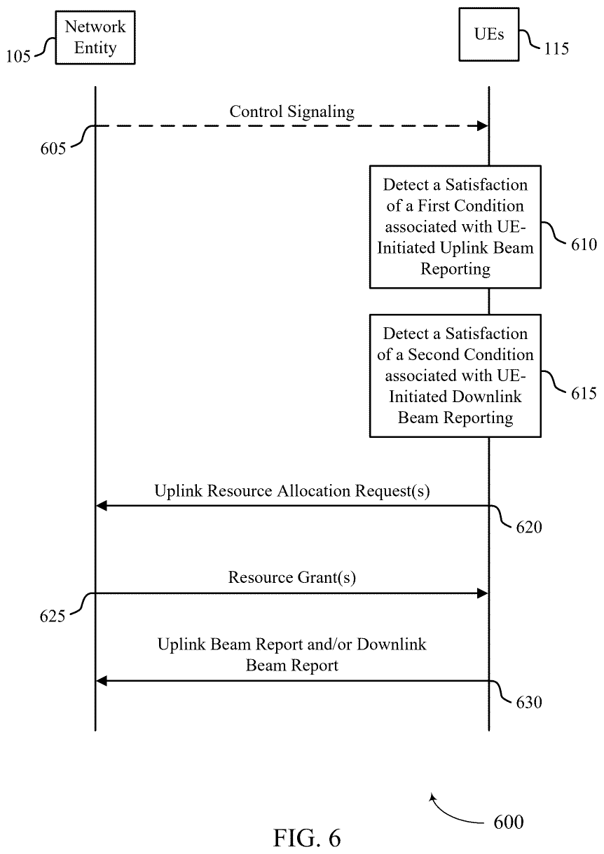

FIG. 6 shows an example of a process flow 600 that supports multiple resource allocation requests in UE-initiated beam reporting in accordance with one or more aspects of the present disclosure. The process flow 600 may implement or be implemented to realize one or more aspects of the wireless communications system 100, the signaling diagram 200, the signaling exchange 300, or the process flow 400. For example, the process flow 600 illustrates communication between a UE 115 and a network entity 105, which may be examples of corresponding devices illustrated and described herein, including by and with reference to FIGS. 1-4.

In the following description of the process flow 600, the operations may be performed (such as reported or provided) in a different order than the order shown, or the operations performed by the example devices may be performed in different orders or at different times. Some operations also may be left out of the process flow 600, or other operations may be added to the process flow 600. Further, although some operations or signaling may be shown to occur at different times for discussion purposes, these operations may actually occur at the same time.

At 605, the UE 115 may receive control signaling from the network entity 105. The control signaling may include DCI, one or more MAC-CEs, RRC signaling, or any combination thereof. The control signaling may be understood as configuration signaling. In some examples, the control signaling may include an indication of one or more PUCCH resources via which the UE 115 may transmit uplink resource allocation requests. In some aspects, the one or more PUCCH resources may include a first PUCCH resource associated with requesting uplink resources for simultaneous downlink and uplink beam report updates and a second PUCCH resource associated with requesting uplink resources for one of a downlink beam report update or an uplink beam report update.

In some aspects, the network entity 105, via the control signaling, may configure the UE 115 with both UE-initiated downlink beam reporting and UE-initiated uplink beam reporting. In some aspects, the control signaling may indicate a quantity of beams (such as N beams, or such as N downlink beams and M uplink beams) and a report quantity to be reported in an uplink beam report or a downlink beam report, or both. In such aspects, the network entity 105 may determine (such as calculate, predict, or anticipate) a size of an uplink beam report or a downlink beam report, or both.

At 610, the UE 115 may detect a satisfaction of a first condition associated with UE-initiated uplink beam reporting. Such a satisfaction of a condition associated with UE-initiated uplink beam reporting may include an occurrence of one or more changes or decisions at the UE 115 that impact one or more uplink beams and one or more downlink beams unequally, as described in more detail with reference to FIG. 3.

At 615, the UE 115 may detect a satisfaction of a second condition associated with UE-initiated downlink beam reporting. Such a satisfaction of a condition associated with UE-initiated downlink beam reporting may be associated with one or more measurements of a current beam or one or more candidate (such as potentially new) beams, as described in more detail with reference to FIG. 2.

In some aspects, the UE 115 may detect the satisfaction of the first condition and the satisfaction of the second condition within a threshold duration of each other. For example, the threshold duration may be defined by a difference between a first time at which the satisfaction of the first condition or the satisfaction of the second condition occurs and a second time at which the UE transmits one or more uplink resource allocation requests. By way of further example, the threshold duration may be defined by a timer that restricts resource allocation requests associated with UE-initiated uplink beam reporting or UE-initiated downlink beam reporting.

At 620, the UE 115 may transmit one or more uplink resource allocation requests in accordance with the satisfaction of the first condition and the second condition. The UE 115 may transmit the one or more uplink resource allocation requests in accordance with one or more signaling mechanisms that define operation at the UE 115 in scenarios in which multiple conditions associated with different types of UE-initiated beam reporting are satisfied within a threshold duration of each other.

In some aspects, the UE 115 may transmit separate uplink resource allocation requests including a first uplink resource allocation request associated with an uplink beam report and a second uplink resource allocation request associated with a downlink beam report. In such aspects, UE-initiated beam report update request processes may be treated (such as managed) separately with potentially separate (such as respective) timelines, configurations, resources, and signaling. In such aspects, the UE 115 and the network entity 105 may realize greater device simplicity by way of enabling relatively simpler device behavior and processing tasks. The UE 115 may transmit the first uplink resource allocation request (for the uplink beam report update) via a periodic or semi-persistent PUCCH resource or may multiplex with the first uplink resource allocation request with an uplink grant (such as a set of uplink resources allocated to the UE 115 by the network entity 105 via a signaled resource grant).

In some aspects, the UE 115 may transmit a single uplink resource allocation request on an earliest PUCCH resource available for UE-initiated reporting. In such aspects, the UE 115 may use the single uplink resource allocation request (such as a single indication, such as a single bit) for a downlink-only beam report, an uplink-only beam report, or a joint downlink and uplink beam report (which the UE 115 may indicate to the network entity 105 via the subsequent beam report that the UE 115 transmits via PUSCH resources). In some aspects, whether the UE 115 uses the single uplink resource allocation request for an uplink beam report or a downlink beam report may be based on an autonomous decision at the UE 115, based on a priority that is specified by a network specification, based on a priority that is signaled by the network entity 105, based on a priority that is associated with an application at or of the UE 115, or based on any combination thereof, among other examples. The UE 115 may transmit the single uplink resource allocation request via a periodic or semi-persistent PUCCH resource.

In some aspects, the UE 115 may transmit a single uplink resource allocation request on a first PUCCH resource that is configured for (requesting uplink resources for) simultaneous downlink and uplink beam report updates. The first PUCCH resource may be understood as a special PUCCH resource that is dedicated to (such as exclusively used for) uplink resource allocation requests transmitted by the UE 115 in scenarios in which both the first condition and the second condition are satisfied (within a threshold duration of each other). In other words, the first PUCCH resource may be separate from a second PUCCH resource configured for (requesting uplink resources for) uplink-only or downlink-only beam reports. The first PUCCH resource may be configured by the network entity 105 as a periodic or semi-persistent PUCCH resource for the UE 115. The first PUCCH resource and the second PUCCH resource may be associated with different frequency domain locations, different time domain occasions, different periodicities, or any combination thereof. In such aspects, the network entity 105 may determine that the UE 115 is requesting uplink resources associated with both an uplink beam report and a downlink beam report in accordance with receiving the uplink resource allocation request via the first PUCCH resource.

In some aspects, the UE 115 may transmit a single uplink resource allocation request via a PUCCH with one or multiple UCI bits reserved to indicate, to the network entity 105, that the UE 115 is requesting uplink resources associated with both an uplink beam report and a downlink beam report. In other words, the single uplink resource allocation request, which may be sent via UCI, may include an indication (via one or multiple bits) that both downlink and uplink UE-initiated beam reports are triggered at the UE 115. The one or multiple UCI bits may be understood as one or multiple special UCI bits. The PUCCH may be a periodic or semi-persistent PUCCH resource and the UE 115 may use the PUCCH resource independent of whether the UE 115 is requesting uplink resources for an uplink-only beam report, a downlink-only beam report, or a joint downlink and uplink beam report. In some aspects, based on the one or multiple bits (such as a bitword associated with the one or multiple bits), the network entity 105 may determine whether the UE 115 is requesting uplink resources for an uplink-only beam report, a downlink-only beam report, or a joint downlink and uplink beam report and may allocate uplink resources to the UE 115 accordingly. For example, in aspects in which the one or multiple UCI bits include two or more bits, a first value indicated by the bits may indicate that the UE 115 is requesting uplink resources for an uplink-only beam report, a second value indicated by the bits may indicate that the UE 115 is requesting uplink resources for a downlink-only beam report, and a third value indicated by the bits may indicate that the UE 115 is requesting uplink resources for a joint downlink and uplink beam report. By way of further example, in aspects in which the one or multiple UCI bits includes a single bit, a first value of the single bit may indicate that the UE 115 is requesting uplink resources for an uplink-only beam report or a downlink-only beam report and a second value of the single bit may indicate that the UE 115 is requesting uplink resources for a joint downlink and uplink beam report.

At 625, the UE 115 may receive one or more resource grants from the network entity 105 in accordance with transmitting the one or more uplink resource allocation requests. The UE 115 may receive a resource grant corresponding to each uplink resource allocation request that the UE 115 transmits. For example, if the UE 115 transmits a single uplink resource allocation request, the UE 115 may receive a single resource grant. By way of further example, if the UE 115 transmits two uplink resource allocation requests, the UE 115 may receive two resource grants.

At 630, the UE 115 may transmit the uplink beam report, the downlink beam report, or both via a set of uplink resources allocated by the one or more resource grants. In some aspects, the UE 115 may transmit the uplink beam report as an uplink-only beam report. Additionally, or alternatively, the UE 115 may transmit the downlink beam report as a downlink-only beam report. Additionally, or alternatively, the UE 115 may transmit the uplink beam report and the downlink beam report as a joint downlink and uplink beam report. In examples in which the UE 115 selects to transmit one of the uplink beam report or the downlink beam report, the UE 115 may select the uplink beam report or the downlink beam report based on an autonomous decision at the UE 115, based on a priority that is specified by a network specification, based on a priority that is signaled by the network entity 105, based on a priority that is associated with an application at or of the UE 115, or based on any combination thereof, among other examples.

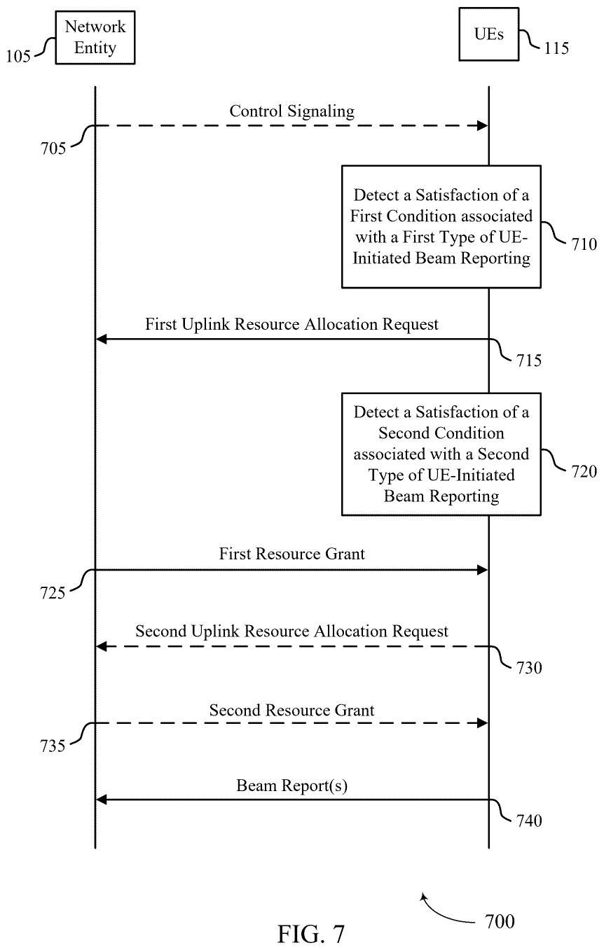

FIG. 7 shows an example of a process flow 700 that supports multiple resource allocation requests in UE-initiated beam reporting in accordance with one or more aspects of the present disclosure. The process flow 700 may implement or be implemented to realize one or more aspects of the wireless communications system 100, the signaling diagram 200, the signaling exchange 300, or the process flow 400. For example, the process flow 700 illustrates communication between a UE 115 and a network entity 105, which may be examples of corresponding devices illustrated and described herein, including by and with reference to FIGS. 1-4.

In the following description of the process flow 700, the operations may be performed (such as reported or provided) in a different order than the order shown, or the operations performed by the example devices may be performed in different orders or at different times. Some operations also may be left out of the process flow 700, or other operations may be added to the process flow 700. Further, although some operations or signaling may be shown to occur at different times for discussion purposes, these operations may actually occur at the same time.

At 705, the UE 115 may receive control signaling from the network entity 105. The control signaling may include DCI, one or more MAC-CEs, RRC signaling, or any combination thereof. The control signaling may be understood as configuration signaling. In some aspects, the network entity 105, via the control signaling, may configure the UE 115 with both UE-initiated downlink beam reporting and UE-initiated uplink beam reporting. In some aspects, the control signaling may indicate a quantity of beams (such as N beams, or such as N downlink beams and M uplink beams) and a report quantity to be reported in an uplink beam report or a downlink beam report, or both. In such aspects, the network entity 105 may determine (such as calculate, predict, or anticipate) a size of an uplink beam report or a downlink beam report, or both.

At 710, the UE 115 may detect a satisfaction of a first condition associated with a first type of UE-initiated beam reporting. The first type of UE-initiated beam reporting may be UE-initiated uplink beam reporting or UE-initiated downlink beam reporting. A satisfaction of a condition associated with UE-initiated uplink beam reporting may include an occurrence of one or more changes or decisions at the UE 115 that impact one or more uplink beams and one or more downlink beams unequally, as described in more detail with reference to FIG. 3. A satisfaction of a condition associated with UE-initiated downlink beam reporting may be associated with one or more measurements of a current beam or one or more candidate (such as potentially new) beams, as described in more detail with reference to FIG. 2.

At 715, the UE 115 may transmit a first uplink resource allocation request associated with a first beam report in accordance with the satisfaction of the first condition associated with the first type of UE-initiated beam reporting. For example, the UE 115 may transmit the first uplink resource allocation request to request uplink resources via which the UE 115 may transmit the first beam report.

At 720, the UE 115 may detect a satisfaction of a second condition associated with a second type of UE-initiated beam reporting. The second type of UE-initiated beam reporting may be the other of UE-initiated uplink beam reporting or UE-initiated downlink beam reporting. The satisfaction of the second condition associated with the second type of UE-initiated beam reporting may trigger a second beam report associated with the second type of UE-initiated beam reporting.

In some aspects, the UE 115 may detect the satisfaction of the second condition associated with the second type of UE-initiated beam reporting while a response to the first uplink resource allocation request is awaited (such as prior to reception of a resource grant associated with the first uplink resource allocation request). In other words, the UE 115 may detect a new triggering event for a second request while a response to a first request is awaited (such as not yet received). In such aspects, the UE 115 may transmit one or more uplink resource allocation requests and may transmit the first beam report, the second beam report, or both in accordance with one or more mechanisms that define operation at the UE 115 in scenarios in which multiple conditions associated with different types of UE-initiated beam reporting are satisfied in accordance with a timeline such that one uplink resource allocation request is transmitted and such that a corresponding resource grant is not yet received prior to the multiple conditions being satisfied.

At 725, for example, the UE 115 may receive a first resource grant associated with the first beam report in accordance with transmitting the first uplink resource allocation request. The UE 115 may receive the first resource grant after the detection of the satisfaction of the second condition associated with the second type of UE-initiated beam reporting.

At 730, in some aspects, the UE 115 may transmit a second uplink resource allocation request associated with the second beam report in accordance with the satisfaction of the second condition associated with the second type of UE-initiated beam reporting. For example, the UE 115 may transmit a second request independent of a response from the network entity 105 associated with a prior a request (such as in accordance with a signaled or network-defined rule). In such aspects, the UE 115 may transmit the second uplink resource allocation request via standalone or separate signaling, such as via a next PUCCH resource that is available for UE-initiated beam reporting.

At 735, in such aspects in which the UE 115 transmits the second uplink resource allocation request as standalone or separate signaling, the UE 115 may receive a second resource grant associated with the second beam report.

At 740, the UE 115 may transmit one or more beam reports. In aspects in which the UE 115 separately receives the first resource grant and the second resource grant, the UE 115 may transmit the first beam report via a first set of uplink resources allocated by the first resource grant and may transmit the second beam report via a second set of uplink resources allocated by the second resource grant.

In some aspects, the UE 115 may transmit the second uplink resource allocation request multiplexed with the first beam report via a set of uplink resources allocated by the first resource grant. In such aspects, for example, the UE 115 may multiplex the second uplink resource allocation request with the first beam report and transmit both via the set of uplink resources allocated by the first resource grant. The UE 115 may multiplex the second uplink resource allocation request with the first beam report as an alternative to transmitting the second uplink resource allocation request via a second PUCCH resource (such as another PUCCH resource different than a first PUCCH resource via which the UE 115 transmits the first uplink resource allocation request at 715).

In some aspects, the UE 115 may refrain from transmitting the second uplink resource allocation request and may attempt to multiplex the second beam report with the first beam report in the set of uplink resources allocated by the first resource grant. In such aspects, for example, the UE 115 may attempt to multiplex the first beam report and the second beam report and transmit both the first beam report and the second beam report via the set of uplink resources allocated by the first resource grant. In scenarios in which the set of uplink resources allocated by the first resource grant is insufficient to carry both the first beam report and the second beam report, the UE 115 may prioritize one of the first beam report or the second beam report. In some examples, the UE 115 may prioritize the first beam report over the second beam report. In some other examples, the UE 115 may prioritize the second beam report over the first beam report. The UE 115 may prioritize one of the first beam report or the second beam report in accordance with an autonomous decision at the UE 115, a priority that is specified by a network specification, a priority that is signaled by the network entity 105, a priority that is associated with an application at or of the UE 115, or based on any combination thereof, among other examples. In some examples, an uplink beam report may have a relatively higher priority, and a downlink beam report may have a relatively lower priority. In some other examples, a downlink beam report may have a relatively higher priority, and an uplink beam report may have a relatively lower priority. In some examples, the UE 115 may completely drop a deprioritized beam report in accordance with an uplink resource insufficiency. In some other examples, the UE 115 may include a portion of a deprioritized beam report in accordance with an uplink resource insufficiency (such as a portion of the deprioritized beam report up until the set of uplink resources allocated by the first resource grant are full or exhausted).

In some aspects, the UE 115 may refrain from transmitting the second uplink resource allocation request and may transmit the first and second beam reports via the set of uplink resources allocated by the first resource grant as a joint beam report, such as a joint downlink and uplink beam report. In such aspects, the UE 115 may transmit the first and second beam reports via the set of uplink resources allocated by the first resource grant as a joint beam report in accordance with a signaled or network-defined rule. In accordance with the signaled or network-defined rule, the network entity 105 may allocate the set of uplink resources via the first resource grant such that the set of uplink resources is sufficient to carry the joint beam report.

The UE 115 and the network entity 105 may coordinate regarding one or more of such aspects that the UE 115 is expected to implement in such scenarios, such as via the control signaling at 705. For example, which one or more aspects that the UE 115 may be expected to implement may be dynamically indicated or configured by the network entity 105 in a scenario-specific fashion (such as, for example, depending on an application at or of the UE 115). The network entity 105 may account for the capability of the UE 115 as part of dynamically indicating or configuring which one or more aspects the UE 115 may be expected to implement. By way of example, the network entity 105 may indicate or configure the UE 115 to transmit separate uplink resource allocation requests within a first time and may indicate or configure the UE 115 to multiplex the first and second beam reports within a second time.

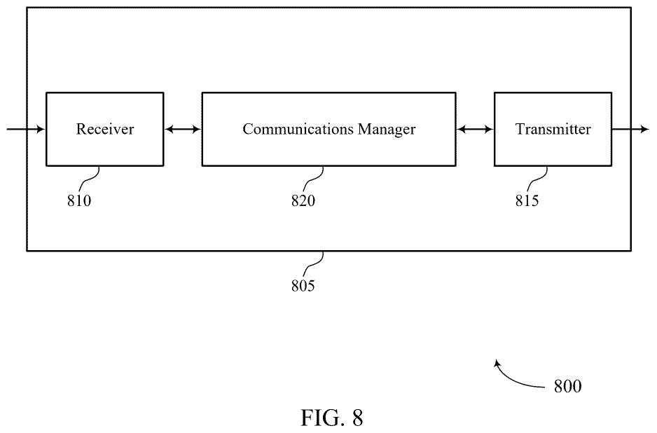

FIG. 8 shows a block diagram 800 of a device 805 that supports multiple resource allocation requests in UE-initiated beam reporting in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to multiple resource allocation requests in UE-initiated beam reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to multiple resource allocation requests in UE-initiated beam reporting). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of multiple resource allocation requests in UE-initiated beam reporting as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting a first uplink resource allocation request associated with an uplink beam report in accordance with a satisfaction of a condition associated with UE-initiated uplink beam reporting at the UE. The communications manager 820 is capable of, configured to, or operable to support a means for monitoring, within a time period indicated by a timer that restricts uplink resource allocation requests associated with UE-initiated uplink beam reports, a downlink control channel for a resource grant associated with the uplink beam report in accordance with transmitting the first uplink resource allocation request. The communications manager 820 is capable of, configured to, or operable to support a means for transmitting a second uplink resource allocation request associated with the uplink beam report in accordance with an absence of the resource grant and an expiration of the timer that restricts the uplink resource allocation requests associated with the UE-initiated uplink beam reports.

Additionally, or alternatively, the communications manager 820 may support wireless communications in accordance with examples as disclosed herein. For example, the communications manager 820 is capable of, configured to, or operable to support a means for transmitting one or more uplink resource allocation requests associated with an uplink beam report, a downlink beam report, or both in accordance with a first satisfaction of a first condition associated with UE-initiated uplink beam reporting at the UE and a second satisfaction of a second condition associated with UE-initiated downlink beam reporting at the UE, where the first satisfaction of the first condition and the second satisfaction of the second condition occur within a threshold duration of each other. The communications manager 820 is capable of, configured to, or operable to support a means for receiving one or more resource grants associated with the uplink beam report, the downlink beam report, or both in accordance with transmitting the one or more uplink resource allocation requests. The communications manager 820 is capable of, configured to, or operable to support a means for transmitting, via a set of uplink resources allocated by the one or more resource grants, the uplink beam report, the downlink beam report, or both.

Additionally, or alternatively, the communications manager 820 may support wireless communications in accordance with examples as disclosed herein. For example, the communications manager 820 is capable of, configured to, or operable to support a means for transmitting a first uplink resource allocation request associated with a first beam report in accordance with a first satisfaction of a first condition associated with a first type of UE-initiated beam reporting at the UE. The communications manager 820 is capable of, configured to, or operable to support a means for receiving a first resource grant associated with the first beam report in accordance with transmitting the first uplink resource allocation request. The communications manager 820 is capable of, configured to, or operable to support a means for transmitting, via at least a first set of uplink resources allocated by the first resource grant, the first beam report, a second beam report, or both in accordance with a second satisfaction, prior to receiving the first resource grant, of a second condition associated with a second type of UE-initiated beam reporting at the UE.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources.

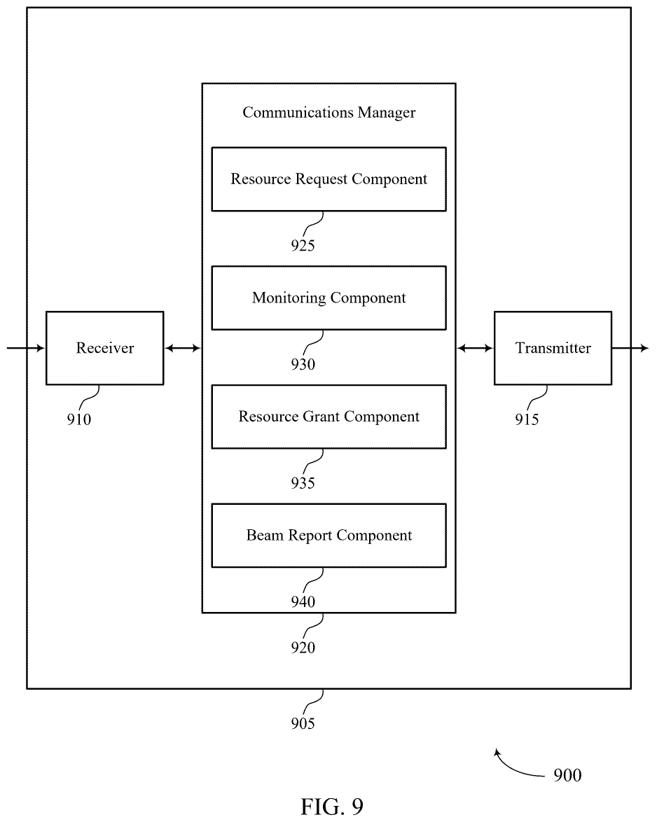

FIG. 9 shows a block diagram 900 of a device 905 that supports multiple resource allocation requests in UE-initiated beam reporting in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to multiple resource allocation requests in UE-initiated beam reporting). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to multiple resource allocation requests in UE-initiated beam reporting). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of multiple resource allocation requests in UE-initiated beam reporting as described herein. For example, the communications manager 920 may include a resource request component 925, a monitoring component 930, a resource grant component 935, a beam report component 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The resource request component 925 is capable of, configured to, or operable to support a means for transmitting a first uplink resource allocation request associated with an uplink beam report in accordance with a satisfaction of a condition associated with UE-initiated uplink beam reporting at the UE. The monitoring component 930 is capable of, configured to, or operable to support a means for monitoring, within a time period indicated by a timer that restricts uplink resource allocation requests associated with UE-initiated uplink beam reports, a downlink control channel for a resource grant associated with the uplink beam report in accordance with transmitting the first uplink resource allocation request. The resource request component 925 is capable of, configured to, or operable to support a means for transmitting a second uplink resource allocation request associated with the uplink beam report in accordance with an absence of the resource grant and an expiration of the timer that restricts the uplink resource allocation requests associated with the UE-initiated uplink beam reports.

Additionally, or alternatively, the communications manager 920 may support wireless communications in accordance with examples as disclosed herein. The resource request component 925 is capable of, configured to, or operable to support a means for transmitting one or more uplink resource allocation requests associated with an uplink beam report, a downlink beam report, or both in accordance with a first satisfaction of a first condition associated with UE-initiated uplink beam reporting at the UE and a second satisfaction of a second condition associated with UE-initiated downlink beam reporting at the UE, where the first satisfaction of the first condition and the second satisfaction of the second condition occur within a threshold duration of each other. The resource grant component 935 is capable of, configured to, or operable to support a means for receiving one or more resource grants associated with the uplink beam report, the downlink beam report, or both in accordance with transmitting the one or more uplink resource allocation requests. The beam report component 940 is capable of, configured to, or operable to support a means for transmitting, via a set of uplink resources allocated by the one or more resource grants, the uplink beam report, the downlink beam report, or both.

Additionally, or alternatively, the communications manager 920 may support wireless communications in accordance with examples as disclosed herein. The resource request component 925 is capable of, configured to, or operable to support a means for transmitting a first uplink resource allocation request associated with a first beam report in accordance with a first satisfaction of a first condition associated with a first type of UE-initiated beam reporting at the UE. The resource grant component 935 is capable of, configured to, or operable to support a means for receiving a first resource grant associated with the first beam report in accordance with transmitting the first uplink resource allocation request. The beam report component 940 is capable of, configured to, or operable to support a means for transmitting, via at least a first set of uplink resources allocated by the first resource grant, the first beam report, a second beam report, or both in accordance with a second satisfaction, prior to receiving the first resource grant, of a second condition associated with a second type of UE-initiated beam reporting at the UE.

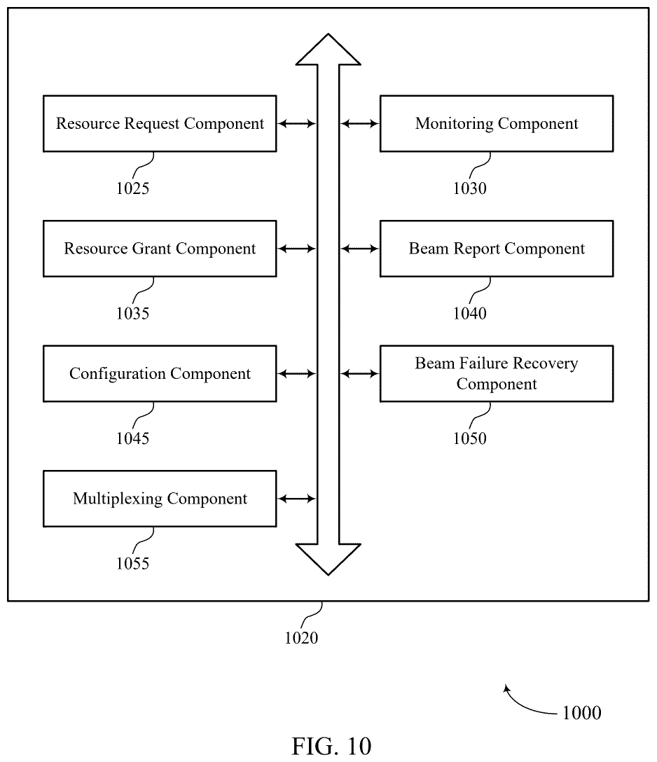

FIG. 10 shows a block diagram 1000 of a communications manager 1020 that supports multiple resource allocation requests in UE-initiated beam reporting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of multiple resource allocation requests in UE-initiated beam reporting as described herein. For example, the communications manager 1020 may include a resource request component 1025, a monitoring component 1030, a resource grant component 1035, a beam report component 1040, a configuration component 1045, a beam failure recovery component 1050, a multiplexing component 1055, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The resource request component 1025 is capable of, configured to, or operable to support a means for transmitting a first uplink resource allocation request associated with an uplink beam report in accordance with a satisfaction of a condition associated with UE-initiated uplink beam reporting at the UE. The monitoring component 1030 is capable of, configured to, or operable to support a means for monitoring, within a time period indicated by a timer that restricts uplink resource allocation requests associated with UE-initiated uplink beam reports, a downlink control channel for a resource grant associated with the uplink beam report in accordance with transmitting the first uplink resource allocation request. In some examples, the resource request component 1025 is capable of, configured to, or operable to support a means for transmitting a second uplink resource allocation request associated with the uplink beam report in accordance with an absence of the resource grant and an expiration of the timer that restricts the uplink resource allocation requests associated with the UE-initiated uplink beam reports.

In some examples, the configuration component 1045 is capable of, configured to, or operable to support a means for receiving, via control signaling, an indication of the timer that restricts the uplink resource allocation requests associated with the UE-initiated uplink beam reports.

In some examples, the configuration component 1045 is capable of, configured to, or operable to support a means for receiving an indication of a subcarrier spacing associated with communications at the UE, where the time period indicated by the timer that restricts the uplink resource allocation requests associated with the UE-initiated uplink beam reports is in accordance with the subcarrier spacing.

In some examples, the time period indicated by the timer that restricts the uplink resource allocation requests associated with the UE-initiated uplink beam reports is fixed and applicable to a set of multiple UEs of a wireless communications system including the UE.

In some examples, the resource request component 1025 is capable of, configured to, or operable to support a means for transmitting up to a threshold quantity of uplink resource allocation requests associated with the uplink beam report in accordance with a continued absence of the resource grant. In some examples, the beam failure recovery component 1050 is capable of, configured to, or operable to support a means for initiating a beam failure recovery procedure based on a failure to receive the resource grant in accordance with transmitting the threshold quantity of uplink resource allocation requests.

In some examples, the resource request component 1025 is capable of, configured to, or operable to support a means for transmitting a set of multiple uplink resource allocation requests associated with the uplink beam report in accordance with a continued absence of the resource grant until a threshold time period from the first uplink resource allocation request is exceeded. In some examples, the beam failure recovery component 1050 is capable of, configured to, or operable to support a means for initiating a beam failure recovery procedure based on a failure to receive the resource grant in accordance with transmitting the set of multiple uplink resource allocation requests until the threshold time period from the first uplink resource allocation request is exceeded.

In some examples, the uplink beam report includes information indicative of one or more uplink metrics associated with one or more reference signals.

In some examples, the time period indicated by the timer starts from a first time at which the UE transmits the first uplink resource allocation request or from an offset relative to the first time. In some examples, the timer expires at or prior to a second time at which the UE transmits the second uplink resource allocation request.

Additionally, or alternatively, the communications manager 1020 may support wireless communications in accordance with examples as disclosed herein. In some examples, the resource request component 1025 is capable of, configured to, or operable to support a means for transmitting one or more uplink resource allocation requests associated with an uplink beam report, a downlink beam report, or both in accordance with a first satisfaction of a first condition associated with UE-initiated uplink beam reporting at the UE and a second satisfaction of a second condition associated with UE-initiated downlink beam reporting at the UE, where the first satisfaction of the first condition and the second satisfaction of the second condition occur within a threshold duration of each other. The resource grant component 1035 is capable of, configured to, or operable to support a means for receiving one or more resource grants associated with the uplink beam report, the downlink beam report, or both in accordance with transmitting the one or more uplink resource allocation requests. The beam report component 1040 is capable of, configured to, or operable to support a means for transmitting, via a set of uplink resources allocated by the one or more resource grants, the uplink beam report, the downlink beam report, or both.

In some examples, to support transmitting the one or more uplink resource allocation requests, the resource request component 1025 is capable of, configured to, or operable to support a means for transmitting a first uplink resource allocation request associated with the uplink beam report in accordance with the first satisfaction of the first condition. In some examples, to support transmitting the one or more uplink resource allocation requests, the resource request component 1025 is capable of, configured to, or operable to support a means for transmitting a second uplink resource allocation request associated with the downlink beam report in accordance with the second satisfaction of the second condition.

In some examples, transmitting the first uplink resource allocation request and the second uplink resource allocation request is in accordance with a rule. In some examples, the rule defines separate uplink resource allocation requests associated with the UE-initiated uplink beam reporting and the UE-initiated downlink beam reporting independent of a timing between the first satisfaction of the first condition and the second satisfaction of the second condition.

In some examples, to support receiving the one or more resource grants, the resource grant component 1035 is capable of, configured to, or operable to support a means for receiving a first resource grant associated with the uplink beam report, where the first resource grant allocates a first set of uplink resources via which the UE transmits the uplink beam report. In some examples, to support receiving the one or more resource grants, the resource grant component 1035 is capable of, configured to, or operable to support a means for receiving a second resource grant associated with the downlink beam report, where the second resource grant allocates a second set of uplink resources via which the UE transmits the downlink beam report.

In some examples, the UE-initiated uplink beam reporting is associated with a first set of one or more timers, a first set of one or more configurations, or a first set of one or more resources. In some examples, the UE-initiated downlink beam reporting is associated with a second set of one or more timers, a second set of one or more configurations, or a second set of one or more resources.

In some examples, to support transmitting the one or more uplink resource allocation requests, the resource request component 1025 is capable of, configured to, or operable to support a means for transmitting a single uplink resource allocation request in accordance with the first satisfaction of the first condition and the second satisfaction of the second condition occurring within the threshold duration of each other.

In some examples, to support receiving the one or more resource grants, the resource grant component 1035 is capable of, configured to, or operable to support a means for receiving a single resource grant in accordance with transmitting the single uplink resource allocation request, where the single resource grant allocates the set of uplink resources, and where the UE transmits the uplink beam report, the downlink beam report, or both as an uplink-only beam report, a downlink-only beam report, or a joint uplink and downlink beam report.

In some examples, the beam report component 1040 is capable of, configured to, or operable to support a means for selecting the uplink beam report, the downlink beam report, or both for transmission via the set of uplink resources in accordance with an autonomous UE decision or a relative priority between the uplink beam report and the downlink beam report.

In some examples, to support transmitting the one or more uplink resource allocation requests, the resource request component 1025 is capable of, configured to, or operable to support a means for transmitting a single uplink resource allocation request via a first uplink control channel resource, of a set of multiple uplink control channel resources, in accordance with the first satisfaction of the first condition and the second satisfaction of the second condition occurring within the threshold duration of each other, where the first uplink control channel resource indicates that a requested resource is associated with a joint uplink and downlink beam report, and where other uplink control channel resources of the set of multiple uplink control channel resources indicate that the requested resource is associated with an uplink-only beam report or a downlink-only beam report.

In some examples, to support receiving the one or more resource grants, the resource grant component 1035 is capable of, configured to, or operable to support a means for receiving a single resource grant in accordance with transmitting the single uplink resource allocation request, where the single resource grant allocates the set of uplink resources, and where the UE transmits the uplink beam report and the downlink beam report as the joint uplink and downlink beam report in accordance with transmitting the single uplink resource allocation request via the first uplink control channel resource.

In some examples, the configuration component 1045 is capable of, configured to, or operable to support a means for receiving, via control signaling, an indication of the first uplink control channel resource that indicates that the requested resource is associated with the joint uplink and downlink beam report, where the control signaling configures the first uplink control channel resource as a periodic uplink control channel resource or a semi-persistent uplink control channel resource.

In some examples, to support transmitting the one or more uplink resource allocation requests, the resource request component 1025 is capable of, configured to, or operable to support a means for transmitting a single uplink resource allocation request in accordance with the first satisfaction of the first condition and the second satisfaction of the second condition occurring within the threshold duration of each other, where the single uplink resource allocation request includes an indication, via one or more bits of the single uplink resource allocation request, that the first satisfaction of the first condition and the second satisfaction of the second condition occurred within the threshold duration of each other.

In some examples, to support receiving the one or more resource grants, the resource grant component 1035 is capable of, configured to, or operable to support a means for receiving a single resource grant in accordance with the indication, where the single resource grant allocates the set of uplink resources, and where the UE transmits the uplink beam report and the downlink beam report as a joint uplink and downlink beam report.

In some examples, a bitword associated with the one or more bits indicates whether a requested resource is associated with an uplink-only beam report, a downlink-only beam report, or a joint uplink and downlink beam report.

In some examples, the uplink beam report includes first information indicative of one or more uplink metrics associated with one or more first reference signals. In some examples, the downlink beam report includes second information indicative of one or more downlink metrics associated with one or more second reference signals.

In some examples, the threshold duration is defined by a difference between a first time at which the first satisfaction of the first condition or the second satisfaction of the second condition occurs and a second time at which the UE transmits the one or more uplink resource allocation requests or is defined by a timer that restricts resource allocation requests associated with UE-initiated uplink beam reports or UE-initiated downlink beam reports.

Additionally, or alternatively, the communications manager 1020 may support wireless communications in accordance with examples as disclosed herein. In some examples, the resource request component 1025 is capable of, configured to, or operable to support a means for transmitting a first uplink resource allocation request associated with a first beam report in accordance with a first satisfaction of a first condition associated with a first type of UE-initiated beam reporting at the UE. In some examples, the resource grant component 1035 is capable of, configured to, or operable to support a means for receiving a first resource grant associated with the first beam report in accordance with transmitting the first uplink resource allocation request. In some examples, the beam report component 1040 is capable of, configured to, or operable to support a means for transmitting, via at least a first set of uplink resources allocated by the first resource grant, the first beam report, a second beam report, or both in accordance with a second satisfaction, prior to receiving the first resource grant, of a second condition associated with a second type of UE-initiated beam reporting at the UE.

In some examples, the resource request component 1025 is capable of, configured to, or operable to support a means for transmitting a second uplink resource allocation request associated with the second beam report in accordance with the second satisfaction of the second condition associated with the second type of UE-initiated beam reporting at the UE. In some examples, the resource grant component 1035 is capable of, configured to, or operable to support a means for receiving a second resource grant associated with the second beam report in accordance with transmitting the second uplink resource allocation request.

In some examples, to support transmitting the first beam report, the second beam report, or both, the beam report component 1040 is capable of, configured to, or operable to support a means for transmitting the first beam report via the first set of uplink resources allocated by the first resource grant. In some examples, to support transmitting the first beam report, the second beam report, or both, the beam report component 1040 is capable of, configured to, or operable to support a means for transmitting the second beam report via a second set of uplink resources allocated by the second resource grant.

In some examples, the multiplexing component 1055 is capable of, configured to, or operable to support a means for multiplexing a second uplink resource allocation request associated with the second beam report with the first beam report. In some examples, the resource grant component 1035 is capable of, configured to, or operable to support a means for receiving a second resource grant associated with the second beam report in accordance with multiplexing the second uplink resource allocation request with the first beam report.

In some examples, to support transmitting the first beam report, the second beam report, or both, the multiplexing component 1055 is capable of, configured to, or operable to support a means for transmitting the first beam report and the second uplink resource allocation request via the first set of uplink resources allocated by the first resource grant. In some examples, to support transmitting the first beam report, the second beam report, or both, the beam report component 1040 is capable of, configured to, or operable to support a means for transmitting the second beam report via a second set of uplink resources allocated by the second resource grant.

In some examples, the multiplexing component 1055 is capable of, configured to, or operable to support a means for multiplexing the first beam report and the second beam report to the first set of uplink resources allocated by the first resource grant, where the UE allocates uplink resources, from the first set of uplink resources, to the first beam report and the second beam report in accordance with a relative priority between the first beam report and the second beam report.

In some examples, the UE prioritizes resource allocation to the first beam report in accordance with the first beam report having a higher priority than the second beam report.

In some examples, the UE transmits the first beam report and the second beam report via the first set of uplink resources allocated by the first resource grant as a joint beam report.

In some examples, the first beam report is a downlink beam report, and the first type of UE-initiated beam reporting is UE-initiated downlink beam reporting. In some examples, the second beam report is an uplink beam report, and the second type of UE-initiated beam reporting is UE-initiated uplink beam reporting.

In some examples, the first beam report is an uplink beam report, and the first type of UE-initiated beam reporting is UE-initiated uplink beam reporting. In some examples, the second beam report is a downlink beam report, and the second type of UE-initiated beam reporting is UE-initiated downlink beam reporting.

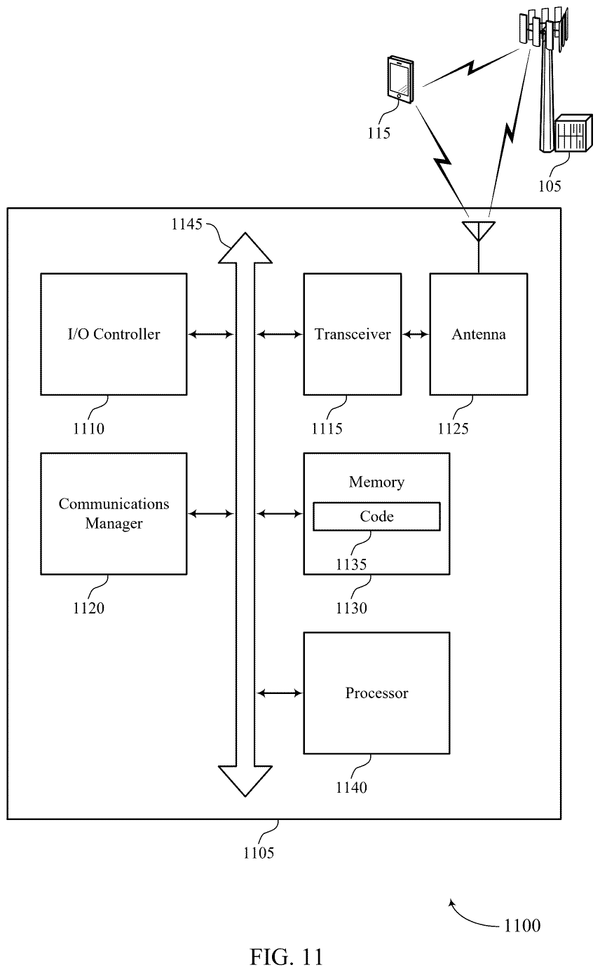

FIG. 11 shows a diagram of a system 1100 including a device 1105 that supports multiple resource allocation requests in UE-initiated beam reporting in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting multiple resource allocation requests in UE-initiated beam reporting). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for transmitting a first uplink resource allocation request associated with an uplink beam report in accordance with a satisfaction of a condition associated with UE-initiated uplink beam reporting at the UE. The communications manager 1120 is capable of, configured to, or operable to support a means for monitoring, within a time period indicated by a timer that restricts uplink resource allocation requests associated with UE-initiated uplink beam reports, a downlink control channel for a resource grant associated with the uplink beam report in accordance with transmitting the first uplink resource allocation request. The communications manager 1120 is capable of, configured to, or operable to support a means for transmitting a second uplink resource allocation request associated with the uplink beam report in accordance with an absence of the resource grant and an expiration of the timer that restricts the uplink resource allocation requests associated with the UE-initiated uplink beam reports.

Additionally, or alternatively, the communications manager 1120 may support wireless communications in accordance with examples as disclosed herein. For example, the communications manager 1120 is capable of, configured to, or operable to support a means for transmitting one or more uplink resource allocation requests associated with an uplink beam report, a downlink beam report, or both in accordance with a first satisfaction of a first condition associated with UE-initiated uplink beam reporting at the UE and a second satisfaction of a second condition associated with UE-initiated downlink beam reporting at the UE, where the first satisfaction of the first condition and the second satisfaction of the second condition occur within a threshold duration of each other. The communications manager 1120 is capable of, configured to, or operable to support a means for receiving one or more resource grants associated with the uplink beam report, the downlink beam report, or both in accordance with transmitting the one or more uplink resource allocation requests. The communications manager 1120 is capable of, configured to, or operable to support a means for transmitting, via a set of uplink resources allocated by the one or more resource grants, the uplink beam report, the downlink beam report, or both.

Additionally, or alternatively, the communications manager 1120 may support wireless communications in accordance with examples as disclosed herein. For example, the communications manager 1120 is capable of, configured to, or operable to support a means for transmitting a first uplink resource allocation request associated with a first beam report in accordance with a first satisfaction of a first condition associated with a first type of UE-initiated beam reporting at the UE. The communications manager 1120 is capable of, configured to, or operable to support a means for receiving a first resource grant associated with the first beam report in accordance with transmitting the first uplink resource allocation request. The communications manager 1120 is capable of, configured to, or operable to support a means for transmitting, via at least a first set of uplink resources allocated by the first resource grant, the first beam report, a second beam report, or both in accordance with a second satisfaction, prior to receiving the first resource grant, of a second condition associated with a second type of UE-initiated beam reporting at the UE.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of multiple resource allocation requests in UE-initiated beam reporting as described herein, or the at least one processor 1140 and the at least one memory 1130 may be otherwise configured to, individually or collectively, perform or support such operations.

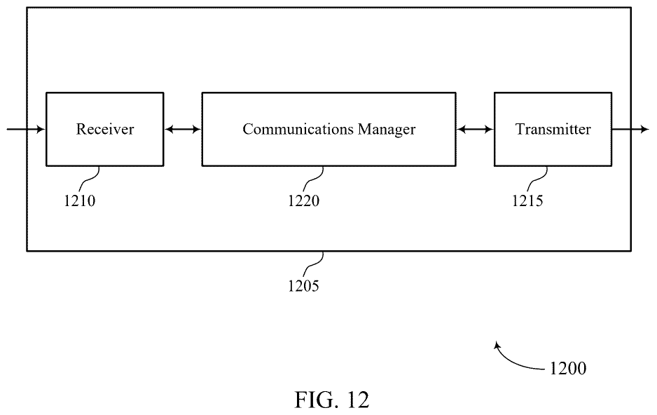

FIG. 12 shows a block diagram 1200 of a device 1205 that supports multiple resource allocation requests in UE-initiated beam reporting in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of multiple resource allocation requests in UE-initiated beam reporting as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for receiving a first uplink resource allocation request associated with an uplink beam report in accordance with a satisfaction of a condition associated with UE-initiated uplink beam reporting at a UE. The communications manager 1220 is capable of, configured to, or operable to support a means for transmitting, within a time period indicated by a timer that restricts uplink resource allocation requests associated with UE-initiated uplink beam reports, a resource grant associated with the uplink beam report in accordance with receiving the first uplink resource allocation request. The communications manager 1220 is capable of, configured to, or operable to support a means for receiving a second uplink resource allocation request associated with the uplink beam report in accordance with a reception failure of the resource grant at the UE and an expiration of the timer that restricts the uplink resource allocation requests associated with the UE-initiated uplink beam reports.

Additionally, or alternatively, the communications manager 1220 may support wireless communications in accordance with examples as disclosed herein. For example, the communications manager 1220 is capable of, configured to, or operable to support a means for receiving one or more uplink resource allocation requests associated with an uplink beam report, a downlink beam report, or both in accordance with a first satisfaction of a first condition associated with UE-initiated uplink beam reporting at a UE and a second satisfaction of a second condition associated with UE-initiated downlink beam reporting at the UE, where the first satisfaction of the first condition and the second satisfaction of the second condition occur within a threshold duration of each other. The communications manager 1220 is capable of, configured to, or operable to support a means for transmitting one or more resource grants associated with the uplink beam report, the downlink beam report, or both in accordance with receiving the one or more uplink resource allocation requests. The communications manager 1220 is capable of, configured to, or operable to support a means for receiving, via a set of uplink resources allocated by the one or more resource grants, the uplink beam report, the downlink beam report, or both.

Additionally, or alternatively, the communications manager 1220 may support wireless communications in accordance with examples as disclosed herein. For example, the communications manager 1220 is capable of, configured to, or operable to support a means for receiving a first uplink resource allocation request associated with a first beam report in accordance with a first satisfaction of a first condition associated with a first type of UE-initiated beam reporting at a UE. The communications manager 1220 is capable of, configured to, or operable to support a means for transmitting a first resource grant associated with the first beam report in accordance with receiving the first uplink resource allocation request. The communications manager 1220 is capable of, configured to, or operable to support a means for receiving, via at least a first set of uplink resources allocated by the first resource grant, the first beam report, a second beam report, or both in accordance with a second satisfaction, prior to transmitting the first resource grant, of a second condition associated with a second type of UE-initiated beam reporting at the UE.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, and more efficient utilization of communication resources.

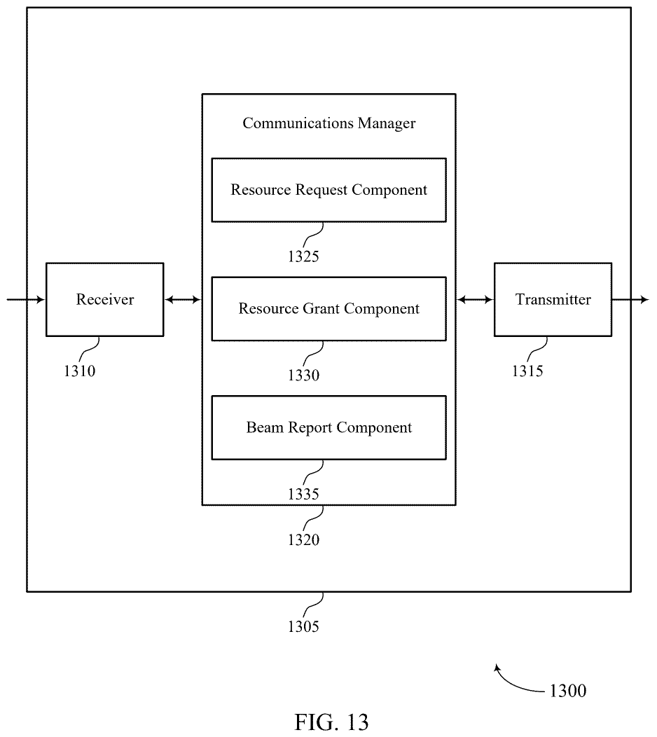

FIG. 13 shows a block diagram 1300 of a device 1305 that supports multiple resource allocation requests in UE-initiated beam reporting in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of multiple resource allocation requests in UE-initiated beam reporting as described herein. For example, the communications manager 1320 may include a resource request component 1325, a resource grant component 1330, a beam report component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The resource request component 1325 is capable of, configured to, or operable to support a means for receiving a first uplink resource allocation request associated with an uplink beam report in accordance with a satisfaction of a condition associated with UE-initiated uplink beam reporting at a UE. The resource grant component 1330 is capable of, configured to, or operable to support a means for transmitting, within a time period indicated by a timer that restricts uplink resource allocation requests associated with UE-initiated uplink beam reports, a resource grant associated with the uplink beam report in accordance with receiving the first uplink resource allocation request. The resource request component 1325 is capable of, configured to, or operable to support a means for receiving a second uplink resource allocation request associated with the uplink beam report in accordance with a reception failure of the resource grant at the UE and an expiration of the timer that restricts the uplink resource allocation requests associated with the UE-initiated uplink beam reports.

Additionally, or alternatively, the communications manager 1320 may support wireless communications in accordance with examples as disclosed herein. The resource request component 1325 is capable of, configured to, or operable to support a means for receiving one or more uplink resource allocation requests associated with an uplink beam report, a downlink beam report, or both in accordance with a first satisfaction of a first condition associated with UE-initiated uplink beam reporting at a UE and a second satisfaction of a second condition associated with UE-initiated downlink beam reporting at the UE, where the first satisfaction of the first condition and the second satisfaction of the second condition occur within a threshold duration of each other. The resource grant component 1330 is capable of, configured to, or operable to support a means for transmitting one or more resource grants associated with the uplink beam report, the downlink beam report, or both in accordance with receiving the one or more uplink resource allocation requests. The beam report component 1335 is capable of, configured to, or operable to support a means for receiving, via a set of uplink resources allocated by the one or more resource grants, the uplink beam report, the downlink beam report, or both.

Additionally, or alternatively, the communications manager 1320 may support wireless communications in accordance with examples as disclosed herein. The resource request component 1325 is capable of, configured to, or operable to support a means for receiving a first uplink resource allocation request associated with a first beam report in accordance with a first satisfaction of a first condition associated with a first type of UE-initiated beam reporting at a UE. The resource grant component 1330 is capable of, configured to, or operable to support a means for transmitting a first resource grant associated with the first beam report in accordance with receiving the first uplink resource allocation request. The beam report component 1335 is capable of, configured to, or operable to support a means for receiving, via at least a first set of uplink resources allocated by the first resource grant, the first beam report, a second beam report, or both in accordance with a second satisfaction, prior to transmitting the first resource grant, of a second condition associated with a second type of UE-initiated beam reporting at the UE.

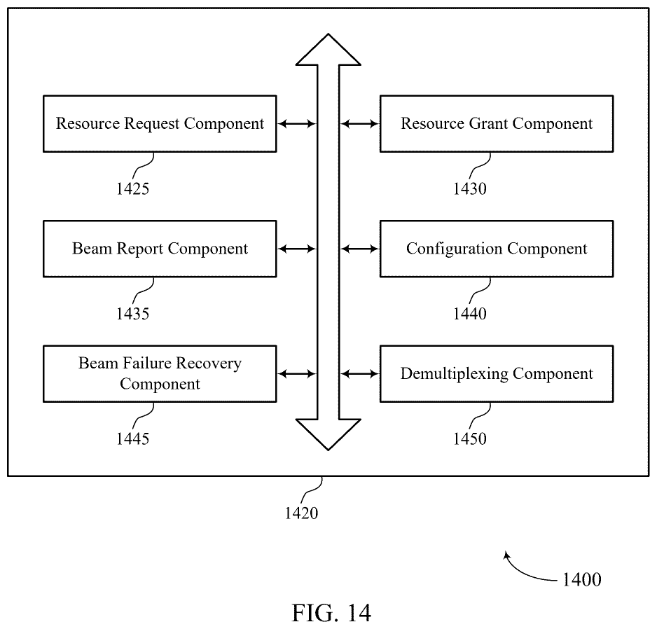

FIG. 14 shows a block diagram 1400 of a communications manager 1420 that supports multiple resource allocation requests in UE-initiated beam reporting in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of multiple resource allocation requests in UE-initiated beam reporting as described herein. For example, the communications manager 1420 may include a resource request component 1425, a resource grant component 1430, a beam report component 1435, a configuration component 1440, a beam failure recovery component 1445, a demultiplexing component 1450, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The resource request component 1425 is capable of, configured to, or operable to support a means for receiving a first uplink resource allocation request associated with an uplink beam report in accordance with a satisfaction of a condition associated with UE-initiated uplink beam reporting at a UE. The resource grant component 1430 is capable of, configured to, or operable to support a means for transmitting, within a time period indicated by a timer that restricts uplink resource allocation requests associated with UE-initiated uplink beam reports, a resource grant associated with the uplink beam report in accordance with receiving the first uplink resource allocation request. In some examples, the resource request component 1425 is capable of, configured to, or operable to support a means for receiving a second uplink resource allocation request associated with the uplink beam report in accordance with a reception failure of the resource grant at the UE and an expiration of the timer that restricts the uplink resource allocation requests associated with the UE-initiated uplink beam reports.

In some examples, the configuration component 1440 is capable of, configured to, or operable to support a means for transmitting, via control signaling, an indication of the timer that restricts the uplink resource allocation requests associated with the UE-initiated uplink beam reports.

In some examples, the configuration component 1440 is capable of, configured to, or operable to support a means for transmitting an indication of a subcarrier spacing associated with communications at the UE, where the time period indicated by the timer that restricts the uplink resource allocation requests associated with the UE-initiated uplink beam reports is in accordance with the subcarrier spacing.

In some examples, the time period indicated by the timer that restricts the uplink resource allocation requests associated with the UE-initiated uplink beam reports is fixed and applicable to a set of multiple UEs of a wireless communications system including the UE.

In some examples, the resource request component 1425 is capable of, configured to, or operable to support a means for receiving up to a threshold quantity of uplink resource allocation requests associated with the uplink beam report in accordance with a continued reception failure of the resource grant at the UE. In some examples, the beam failure recovery component 1445 is capable of, configured to, or operable to support a means for participating in a beam failure recovery procedure with the UE based on receiving the threshold quantity of uplink resource allocation requests.

In some examples, the resource request component 1425 is capable of, configured to, or operable to support a means for receiving a set of multiple uplink resource allocation requests associated with the uplink beam report in accordance with a continued reception failure of the resource grant at the UE until a threshold time period from the first uplink resource allocation request is exceeded. In some examples, the beam failure recovery component 1445 is capable of, configured to, or operable to support a means for participating in a beam failure recovery procedure with the UE based on the threshold time period from the first uplink resource allocation request being exceeded prior to a successful reception of the resource grant at the UE.

In some examples, the uplink beam report includes information indicative of one or more uplink metrics associated with one or more reference signals.

In some examples, the time period indicated by the timer starts from a first time at which the network entity receives the first uplink resource allocation request or from an offset relative to the first time. In some examples, the timer expires at or prior to a second time at which the network entity receives the second uplink resource allocation request.

Additionally, or alternatively, the communications manager 1420 may support wireless communications in accordance with examples as disclosed herein. In some examples, the resource request component 1425 is capable of, configured to, or operable to support a means for receiving one or more uplink resource allocation requests associated with an uplink beam report, a downlink beam report, or both in accordance with a first satisfaction of a first condition associated with UE-initiated uplink beam reporting at a UE and a second satisfaction of a second condition associated with UE-initiated downlink beam reporting at the UE, where the first satisfaction of the first condition and the second satisfaction of the second condition occur within a threshold duration of each other. In some examples, the resource grant component 1430 is capable of, configured to, or operable to support a means for transmitting one or more resource grants associated with the uplink beam report, the downlink beam report, or both in accordance with receiving the one or more uplink resource allocation requests. The beam report component 1435 is capable of, configured to, or operable to support a means for receiving, via a set of uplink resources allocated by the one or more resource grants, the uplink beam report, the downlink beam report, or both.

In some examples, to support receiving the one or more uplink resource allocation requests, the resource request component 1425 is capable of, configured to, or operable to support a means for receiving a first uplink resource allocation request associated with the uplink beam report in accordance with the first satisfaction of the first condition. In some examples, to support receiving the one or more uplink resource allocation requests, the resource request component 1425 is capable of, configured to, or operable to support a means for receiving a second uplink resource allocation request associated with the downlink beam report in accordance with the second satisfaction of the second condition.

In some examples, receiving the first uplink resource allocation request and the second uplink resource allocation request is in accordance with a rule. In some examples, the rule defines separate uplink resource allocation requests associated with the UE-initiated uplink beam reporting and the UE-initiated downlink beam reporting independent of a timing between the first satisfaction of the first condition and the second satisfaction of the second condition.

In some examples, to support transmitting the one or more resource grants, the resource grant component 1430 is capable of, configured to, or operable to support a means for transmitting a first resource grant associated with the uplink beam report, where the first resource grant allocates a first set of uplink resources via which the UE is to transmit the uplink beam report. In some examples, to support transmitting the one or more resource grants, the resource grant component 1430 is capable of, configured to, or operable to support a means for transmitting a second resource grant associated with the downlink beam report, where the second resource grant allocates a second set of uplink resources via which the UE is to transmit the downlink beam report.

In some examples, the UE-initiated uplink beam reporting is associated with a first set of one or more timers, a first set of one or more configurations, or a first set of one or more resources. In some examples, the UE-initiated downlink beam reporting is associated with a second set of one or more timers, a second set of one or more configurations, or a second set of one or more resources.

In some examples, to support receiving the one or more uplink resource allocation requests, the resource request component 1425 is capable of, configured to, or operable to support a means for receiving a single uplink resource allocation request in accordance with the first satisfaction of the first condition and the second satisfaction of the second condition occurring within the threshold duration of each other.

In some examples, to support transmitting the one or more resource grants, the resource grant component 1430 is capable of, configured to, or operable to support a means for transmitting a single resource grant in accordance with receiving the single uplink resource allocation request, where the single resource grant allocates the set of uplink resources, and where the network entity receives the uplink beam report, the downlink beam report, or both as an uplink-only beam report, a downlink-only beam report, or a joint uplink and downlink beam report.

In some examples, to support receiving the uplink beam report, the downlink beam report, or both, the beam report component 1435 is capable of, configured to, or operable to support a means for receiving the uplink beam report, the downlink beam report, or both via the set of uplink resources in accordance with an autonomous UE decision or a relative priority between the uplink beam report and the downlink beam report.

In some examples, to support receiving the one or more uplink resource allocation requests, the resource request component 1425 is capable of, configured to, or operable to support a means for receiving a single uplink resource allocation request via a first uplink control channel resource, of a set of multiple uplink control channel resources, in accordance with the first satisfaction of the first condition and the second satisfaction of the second condition occurring within the threshold duration of each other, where the first uplink control channel resource indicates that a requested resource is associated with a joint uplink and downlink beam report, and where other uplink control channel resources of the set of multiple uplink control channel resources indicate that the requested resource is associated with an uplink-only beam report or a downlink-only beam report.

In some examples, to support transmitting the one or more resource grants, the resource grant component 1430 is capable of, configured to, or operable to support a means for transmitting a single resource grant in accordance with receiving the single uplink resource allocation request, where the single resource grant allocates the set of uplink resources, and where the network entity receives the uplink beam report and the downlink beam report as the joint uplink and downlink beam report in accordance with receiving the single uplink resource allocation request via the first uplink control channel resource.

In some examples, the configuration component 1440 is capable of, configured to, or operable to support a means for transmitting, via control signaling, an indication of the first uplink control channel resource that indicates that the requested resource is associated with the joint uplink and downlink beam report, where the control signaling configures the first uplink control channel resource as a periodic uplink control channel resource or a semi-persistent uplink control channel resource.

In some examples, to support receiving the one or more uplink resource allocation requests, the resource request component 1425 is capable of, configured to, or operable to support a means for receiving a single uplink resource allocation request in accordance with the first satisfaction of the first condition and the second satisfaction of the second condition occurring within the threshold duration of each other, where the single uplink resource allocation request includes an indication, via one or more bits of the single uplink resource allocation request, that the first satisfaction of the first condition and the second satisfaction of the second condition occurred within the threshold duration of each other.

In some examples, to support transmitting the one or more resource grants, the resource grant component 1430 is capable of, configured to, or operable to support a means for transmitting a single resource grant in accordance with the indication, where the single resource grant allocates the set of uplink resources, and where the network entity receives the uplink beam report and the downlink beam report as a joint uplink and downlink beam report.

In some examples, a bitword associated with the one or more bits indicates whether a requested resource is associated with an uplink-only beam report, a downlink-only beam report, or a joint uplink and downlink beam report.

In some examples, the uplink beam report includes first information indicative of one or more uplink metrics associated with one or more first reference signals. In some examples, the downlink beam report includes second information indicative of one or more downlink metrics associated with one or more second reference signals.

In some examples, the threshold duration is defined by a difference between a first time at which the first satisfaction of the first condition or the second satisfaction of the second condition occurs and a second time at which the UE transmits the one or more uplink resource allocation requests or is defined by a timer that restricts resource allocation requests associated with UE-initiated uplink beam reports or UE-initiated downlink beam reports.

Additionally, or alternatively, the communications manager 1420 may support wireless communications in accordance with examples as disclosed herein. In some examples, the resource request component 1425 is capable of, configured to, or operable to support a means for receiving a first uplink resource allocation request associated with a first beam report in accordance with a first satisfaction of a first condition associated with a first type of UE-initiated beam reporting at a UE. In some examples, the resource grant component 1430 is capable of, configured to, or operable to support a means for transmitting a first resource grant associated with the first beam report in accordance with receiving the first uplink resource allocation request. In some examples, the beam report component 1435 is capable of, configured to, or operable to support a means for receiving, via at least a first set of uplink resources allocated by the first resource grant, the first beam report, a second beam report, or both in accordance with a second satisfaction, prior to transmitting the first resource grant, of a second condition associated with a second type of UE-initiated beam reporting at the UE.

In some examples, the resource request component 1425 is capable of, configured to, or operable to support a means for receiving a second uplink resource allocation request associated with the second beam report in accordance with the second satisfaction of the second condition associated with the second type of UE-initiated beam reporting at the UE. In some examples, the resource grant component 1430 is capable of, configured to, or operable to support a means for transmitting a second resource grant associated with the second beam report in accordance with receiving the second uplink resource allocation request.

In some examples, to support receiving the first beam report, the second beam report, or both, the beam report component 1435 is capable of, configured to, or operable to support a means for receiving the first beam report via the first set of uplink resources allocated by the first resource grant. In some examples, to support receiving the first beam report, the second beam report, or both, the beam report component 1435 is capable of, configured to, or operable to support a means for receiving the second beam report via a second set of uplink resources allocated by the second resource grant.

In some examples, the demultiplexing component 1450 is capable of, configured to, or operable to support a means for demultiplexing a second uplink resource allocation request associated with the second beam report from the first beam report. In some examples, the resource grant component 1430 is capable of, configured to, or operable to support a means for transmitting a second resource grant associated with the second beam report in accordance with demultiplexing the second uplink resource allocation request from the first beam report.

In some examples, to support receiving the first beam report, the second beam report, or both, the demultiplexing component 1450 is capable of, configured to, or operable to support a means for receiving the first beam report and the second uplink resource allocation request via the first set of uplink resources allocated by the first resource grant. In some examples, to support receiving the first beam report, the second beam report, or both, the beam report component 1435 is capable of, configured to, or operable to support a means for receiving the second beam report via a second set of uplink resources allocated by the second resource grant.

In some examples, the demultiplexing component 1450 is capable of, configured to, or operable to support a means for demultiplexing the first beam report and the second beam report from the first set of uplink resources allocated by the first resource grant, where uplink resources, from the first set of uplink resources, are allocated to the first beam report and the second beam report in accordance with a relative priority between the first beam report and the second beam report.

In some examples, resource allocation to the first beam report is prioritized in accordance with the first beam report having a higher priority than the second beam report.

In some examples, the network entity receives the first beam report and the second beam report via the first set of uplink resources allocated by the first resource grant as a joint beam report.

In some examples, the first beam report is a downlink beam report, and the first type of UE-initiated beam reporting is UE-initiated downlink beam reporting. In some examples, the second beam report is an uplink beam report, and the second type of UE-initiated beam reporting is UE-initiated uplink beam reporting.

In some examples, the first beam report is an uplink beam report, and the first type of UE-initiated beam reporting is UE-initiated uplink beam reporting. In some examples, the second beam report is a downlink beam report, and the second type of UE-initiated beam reporting is UE-initiated downlink beam reporting.

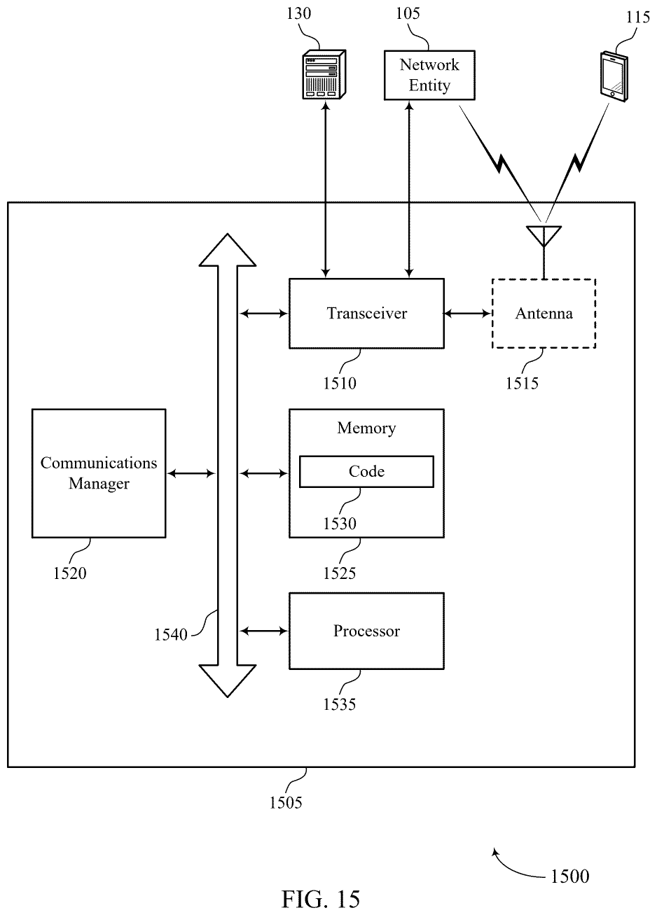

FIG. 15 shows a diagram of a system 1500 including a device 1505 that supports multiple resource allocation requests in UE-initiated beam reporting in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some aspects, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some aspects, the transceiver 1510 may include or be configured for coupling with one or more processors or one or more memory components that are operable to perform or support operations based on received or obtained information or signals, or to generate information or other signals for transmission or other outputting, or any combination thereof. In some aspects, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting multiple resource allocation requests in UE-initiated beam reporting). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105 and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for receiving a first uplink resource allocation request associated with an uplink beam report in accordance with a satisfaction of a condition associated with UE-initiated uplink beam reporting at a UE. The communications manager 1520 is capable of, configured to, or operable to support a means for transmitting, within a time period indicated by a timer that restricts uplink resource allocation requests associated with UE-initiated uplink beam reports, a resource grant associated with the uplink beam report in accordance with receiving the first uplink resource allocation request. The communications manager 1520 is capable of, configured to, or operable to support a means for receiving a second uplink resource allocation request associated with the uplink beam report in accordance with a reception failure of the resource grant at the UE and an expiration of the timer that restricts the uplink resource allocation requests associated with the UE-initiated uplink beam reports.

Additionally, or alternatively, the communications manager 1520 may support wireless communications in accordance with examples as disclosed herein. For example, the communications manager 1520 is capable of, configured to, or operable to support a means for receiving one or more uplink resource allocation requests associated with an uplink beam report, a downlink beam report, or both in accordance with a first satisfaction of a first condition associated with UE-initiated uplink beam reporting at a UE and a second satisfaction of a second condition associated with UE-initiated downlink beam reporting at the UE, where the first satisfaction of the first condition and the second satisfaction of the second condition occur within a threshold duration of each other. The communications manager 1520 is capable of, configured to, or operable to support a means for transmitting one or more resource grants associated with the uplink beam report, the downlink beam report, or both in accordance with receiving the one or more uplink resource allocation requests. The communications manager 1520 is capable of, configured to, or operable to support a means for receiving, via a set of uplink resources allocated by the one or more resource grants, the uplink beam report, the downlink beam report, or both.

Additionally, or alternatively, the communications manager 1520 may support wireless communications in accordance with examples as disclosed herein. For example, the communications manager 1520 is capable of, configured to, or operable to support a means for receiving a first uplink resource allocation request associated with a first beam report in accordance with a first satisfaction of a first condition associated with a first type of UE-initiated beam reporting at a UE. The communications manager 1520 is capable of, configured to, or operable to support a means for transmitting a first resource grant associated with the first beam report in accordance with receiving the first uplink resource allocation request. The communications manager 1520 is capable of, configured to, or operable to support a means for receiving, via at least a first set of uplink resources allocated by the first resource grant, the first beam report, a second beam report, or both in accordance with a second satisfaction, prior to transmitting the first resource grant, of a second condition associated with a second type of UE-initiated beam reporting at the UE.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of multiple resource allocation requests in UE-initiated beam reporting as described herein, or the at least one processor 1535 and the at least one memory 1525 may be otherwise configured to, individually or collectively, perform or support such operations.

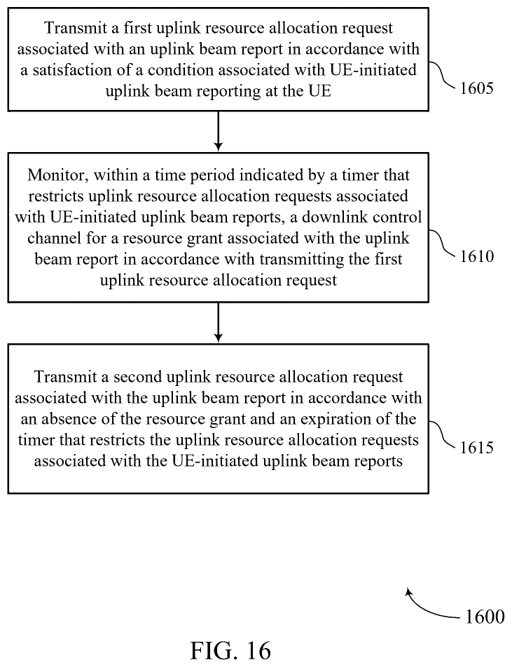

FIG. 16 shows a flowchart illustrating a method 1600 that supports multiple resource allocation requests in UE-initiated beam reporting in accordance with one or more aspects of the present disclosure. The operations of the method 1600 may be implemented by a UE or its components as described herein. For example, the operations of the method 1600 may be performed by a UE 115 as described with reference to FIGS. 1-11. In some examples, a UE may execute a set of instructions to control the functional elements of the UE to perform the described functions. Additionally, or alternatively, the UE may perform aspects of the described functions using special-purpose hardware.

At 1605, the method may include transmitting a first uplink resource allocation request associated with an uplink beam report in accordance with a satisfaction of a condition associated with UE-initiated uplink beam reporting at the UE. The operations of 1605 may be performed in accordance with examples as disclosed herein, such as in accordance with the transmission of the first uplink resource allocation request at 515 of FIG. 5. The first uplink resource allocation request may be an example of the uplink resource allocation request 315 of FIG. 3. In some examples, aspects of the operations of 1605 may be performed by a resource request component 1025 as described with reference to FIG. 10. Additionally, or alternatively, aspects of the operations of 1605 may be performed by the device 1105 in association with the at least one processor 1140 executing the code 1135 stored in the at least one memory 1130, as described with reference to FIG. 11.

At 1610, the method may include monitoring, within a time period indicated by a timer that restricts uplink resource allocation requests associated with UE-initiated uplink beam reports, a downlink control channel for a resource grant associated with the uplink beam report in accordance with transmitting the first uplink resource allocation request. The operations of 1610 may be performed in accordance with examples as disclosed herein, such as in accordance with the monitoring of the PDCCH for a resource grant within a time period 520 of FIG. 5. The resource grant may be an example of a resource grant transmitted by the network entity 105 at 525 of FIG. 5. The resource grant may also be an example of the resource grant 320 of FIG. 3. In some examples, aspects of the operations of 1610 may be performed by a monitoring component 1030 as described with reference to FIG. 10. Additionally, or alternatively, aspects of the operations of 1610 may be performed by the device 1105 in association with the at least one processor 1140 executing the code 1135 stored in the at least one memory 1130, as described with reference to FIG. 11.

At 1615, the method may include transmitting a second uplink resource allocation request associated with the uplink beam report in accordance with an absence of the resource grant and an expiration of the timer that restricts the uplink resource allocation requests associated with the UE-initiated uplink beam reports. The operations of 1615 may be performed in accordance with examples as disclosed herein, such as in accordance with the transmission of the second uplink resource allocation request at 530 of FIG. 5. The second uplink resource allocation request may be an example of a retransmission of the uplink resource allocation request 315 or any other uplink resource allocation request that the UE 115 may transmit as part of UE-initiated uplink beam reporting. In some examples, aspects of the operations of 1615 may be performed by a resource request component 1025 as described with reference to FIG. 10. Additionally, or alternatively, aspects of the operations of 1615 may be performed by the device 1105 in association with the at least one processor 1140 executing the code 1135 stored in the at least one memory 1130, as described with reference to FIG. 11.

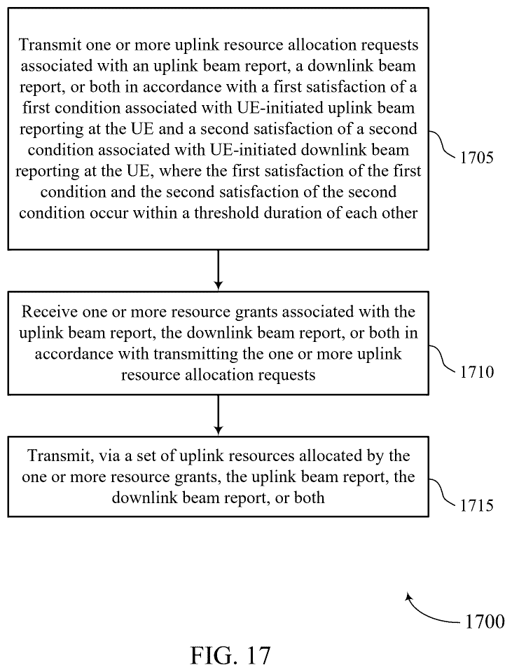

FIG. 17 shows a flowchart illustrating a method 1700 that supports multiple resource allocation requests in UE-initiated beam reporting in accordance with one or more aspects of the present disclosure. The operations of the method 1700 may be implemented by a UE or its components as described herein. For example, the operations of the method 1700 may be performed by a UE 115 as described with reference to FIGS. 1-11. In some examples, a UE may execute a set of instructions to control the functional elements of the UE to perform the described functions. Additionally, or alternatively, the UE may perform aspects of the described functions using special-purpose hardware.

At 1705, the method may include transmitting one or more uplink resource allocation requests associated with an uplink beam report, a downlink beam report, or both in accordance with a first satisfaction of a first condition associated with UE-initiated uplink beam reporting at the UE and a second satisfaction of a second condition associated with UE-initiated downlink beam reporting at the UE, where the first satisfaction of the first condition and the second satisfaction of the second condition occur within a threshold duration of each other. The operations of 1705 may be performed in accordance with examples as disclosed herein, such as in accordance with the transmission of the one or more uplink resource allocation requests at 630 of FIG. 6. The one or more uplink resource allocation requests may be examples of one or more uplink resource allocation requests 315 of FIG. 3. In some examples, aspects of the operations of 1705 may be performed by a resource request component 1025 as described with reference to FIG. 10. Additionally, or alternatively, aspects of the operations of 1705 may be performed by the device 1105 in association with the at least one processor 1140 executing the code 1135 stored in the at least one memory 1130, as described with reference to FIG. 11.

At 1710, the method may include receiving one or more resource grants associated with the uplink beam report, the downlink beam report, or both in accordance with transmitting the one or more uplink resource allocation requests. The operations of 1710 may be performed in accordance with examples as disclosed herein, such as in accordance with the reception of the one or more resource grants at 625 of FIG. 6. The one or more resource grants may be examples of one or more resource grants 320 of FIG. 3. In some examples, aspects of the operations of 1710 may be performed by a resource grant component 1035 as described with reference to FIG. 10. Additionally, or alternatively, aspects of the operations of 1710 may be performed by the device 1105 in association with the at least one processor 1140 executing the code 1135 stored in the at least one memory 1130, as described with reference to FIG. 11.

At 1715, the method may include transmitting, via a set of uplink resources allocated by the one or more resource grants, the uplink beam report, the downlink beam report, or both. The operations of 1715 may be performed in accordance with examples as disclosed herein, such as in accordance with the transmission of the uplink beam report, the downlink beam report, or both at 630 of FIG. 6. The uplink beam report may be an example of the uplink beam report 325 of FIG. 3. In some examples, aspects of the operations of 1715 may be performed by a beam report component 1040 as described with reference to FIG. 10. Additionally, or alternatively, aspects of the operations of 1715 may be performed by the device 1105 in association with the at least one processor 1140 executing the code 1135 stored in the at least one memory 1130, as described with reference to FIG. 11.

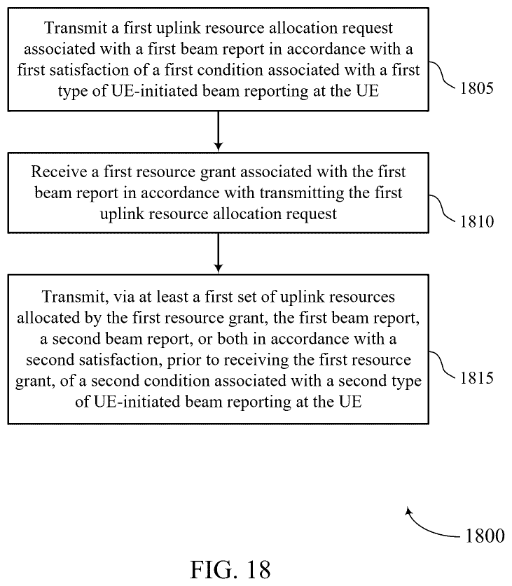

FIG. 18 shows a flowchart illustrating a method 1800 that supports multiple resource allocation requests in UE-initiated beam reporting in accordance with one or more aspects of the present disclosure. The operations of the method 1800 may be implemented by a UE or its components as described herein. For example, the operations of the method 1800 may be performed by a UE 115 as described with reference to FIGS. 1-11. In some examples, a UE may execute a set of instructions to control the functional elements of the UE to perform the described functions. Additionally, or alternatively, the UE may perform aspects of the described functions using special-purpose hardware.

At 1805, the method may include transmitting a first uplink resource allocation request associated with a first beam report in accordance with a first satisfaction of a first condition associated with a first type of UE-initiated beam reporting at the UE. The operations of 1805 may be performed in accordance with examples as disclosed herein, such as in accordance with the transmission of the first uplink resource allocation request at 715 of FIG. 7. The first uplink resource allocation request may be an example of the uplink resource allocation request 315 of FIG. 3. In some examples, aspects of the operations of 1805 may be performed by a resource request component 1025 as described with reference to FIG. 10. Additionally, or alternatively, aspects of the operations of 1805 may be performed by the device 1105 in association with the at least one processor 1140 executing the code 1135 stored in the at least one memory 1130, as described with reference to FIG. 11.

At 1810, the method may include receiving a first resource grant associated with the first beam report in accordance with transmitting the first uplink resource allocation request. The operations of 1810 may be performed in accordance with examples as disclosed herein, such as in accordance with the reception of the first resource grant at 725 of FIG. 7. The first resource grant may be an example of the resource grant 320 of FIG. 3. In some examples, aspects of the operations of 1810 may be performed by a resource grant component 1035 as described with reference to FIG. 10. Additionally, or alternatively, aspects of the operations of 1810 may be performed by the device 1105 in association with the at least one processor 1140 executing the code 1135 stored in the at least one memory 1130, as described with reference to FIG. 11.

At 1815, the method may include transmitting, via at least a first set of uplink resources allocated by the first resource grant, the first beam report, a second beam report, or both in accordance with a second satisfaction, prior to receiving the first resource grant, of a second condition associated with a second type of UE-initiated beam reporting at the UE. The operations of 1815 may be performed in accordance with examples as disclosed herein, such as in accordance with the transmission of the one or more beam reports at 740 of FIG. 7. The first beam report may be an example of an uplink beam report or a downlink beam report, and the second beam report may be an example of the other of the uplink beam report or the downlink beam report. In some examples, aspects of the operations of 1815 may be performed by a beam report component 1040 as described with reference to FIG. 10. Additionally, or alternatively, aspects of the operations of 1815 may be performed by the device 1105 in association with the at least one processor 1140 executing the code 1135 stored in the at least one memory 1130, as described with reference to FIG. 11.

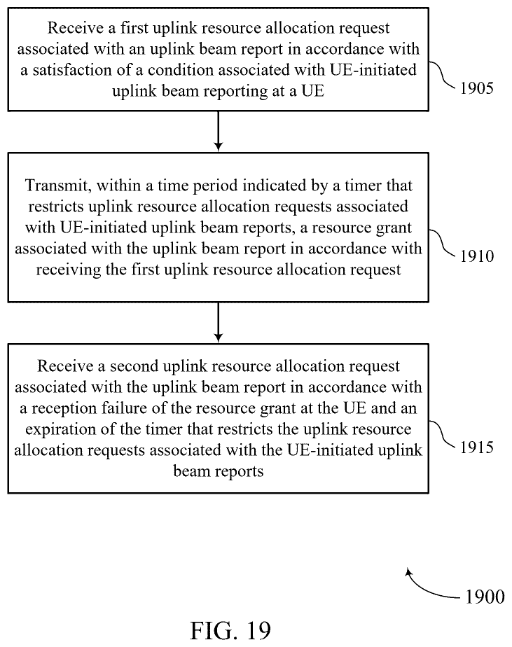

FIG. 19 shows a flowchart illustrating a method 1900 that supports multiple resource allocation requests in UE-initiated beam reporting in accordance with one or more aspects of the present disclosure. The operations of the method 1900 may be implemented by a network entity or its components as described herein. For example, the operations of the method 1900 may be performed by a network entity as described with reference to FIGS. 1-7 and 12-15. In some examples, a network entity may execute a set of instructions to control the functional elements of the network entity to perform the described functions. Additionally, or alternatively, the network entity may perform aspects of the described functions using special-purpose hardware.

At 1905, the method may include receiving a first uplink resource allocation request associated with an uplink beam report in accordance with a satisfaction of a condition associated with UE-initiated uplink beam reporting at a UE. The operations of 1905 may be performed in accordance with examples as disclosed herein, such as in accordance with the reception of the first uplink resource allocation request at 515 of FIG. 5. The first uplink resource allocation request may be an example of the uplink resource allocation request 315 of FIG. 3. In some examples, aspects of the operations of 1905 may be performed by a resource request component 1425 as described with reference to FIG. 14. Additionally, or alternatively, aspects of the operations of 1905 may be performed by the device 1505 in association with the at least one processor 1535 executing the code 1530 stored in the at least one memory 1525, as described with reference to FIG. 15.

At 1910, the method may include transmitting, within a time period indicated by a timer that restricts uplink resource allocation requests associated with UE-initiated uplink beam reports, a resource grant associated with the uplink beam report in accordance with receiving the first uplink resource allocation request. The operations of 1910 may be performed in accordance with examples as disclosed herein, such as in accordance with the transmission of the resource grant at 525 of FIG. 5. The resource grant may be an example of the resource grant 320 of FIG. 3. In some examples, aspects of the operations of 1910 may be performed by a resource grant component 1430 as described with reference to FIG. 14. Additionally, or alternatively, aspects of the operations of 1910 may be performed by the device 1505 in association with the at least one processor 1535 executing the code 1530 stored in the at least one memory 1525, as described with reference to FIG. 15.

At 1915, the method may include receiving a second uplink resource allocation request associated with the uplink beam report in accordance with a reception failure of the resource grant at the UE and an expiration of the timer that restricts the uplink resource allocation requests associated with the UE-initiated uplink beam reports. The operations of 1915 may be performed in accordance with examples as disclosed herein, such as in accordance with the reception of the second uplink resource allocation request at 530 of FIG. 5. The second uplink resource allocation request may be an example of a retransmission of the uplink resource allocation request 315 or any other uplink resource allocation request that the UE 115 may transmit as part of UE-initiated uplink beam reporting. In some examples, aspects of the operations of 1915 may be performed by a resource request component 1425 as described with reference to FIG. 14. Additionally, or alternatively, aspects of the operations of 1915 may be performed by the device 1505 in association with the at least one processor 1535 executing the code 1530 stored in the at least one memory 1525, as described with reference to FIG. 15.

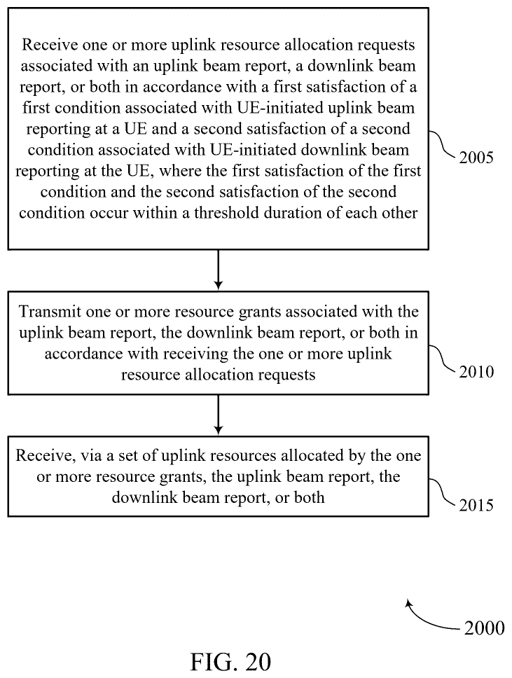

FIG. 20 shows a flowchart illustrating a method 2000 that supports multiple resource allocation requests in UE-initiated beam reporting in accordance with one or more aspects of the present disclosure. The operations of the method 2000 may be implemented by a network entity or its components as described herein. For example, the operations of the method 2000 may be performed by a network entity as described with reference to FIGS. 1-7 and 12-15. In some examples, a network entity may execute a set of instructions to control the functional elements of the network entity to perform the described functions. Additionally, or alternatively, the network entity may perform aspects of the described functions using special-purpose hardware.

At 2005, the method may include receiving one or more uplink resource allocation requests associated with an uplink beam report, a downlink beam report, or both in accordance with a first satisfaction of a first condition associated with UE-initiated uplink beam reporting at a UE and a second satisfaction of a second condition associated with UE-initiated downlink beam reporting at the UE, where the first satisfaction of the first condition and the second satisfaction of the second condition occur within a threshold duration of each other. The operations of 2005 may be performed in accordance with examples as disclosed herein, such as in accordance with the reception of the one or more uplink resource allocation requests at 630 of FIG. 6. The one or more uplink resource allocation requests may be examples of one or more uplink resource allocation requests 315 of FIG. 3. In some examples, aspects of the operations of 2005 may be performed by a resource request component 1425 as described with reference to FIG. 14. Additionally, or alternatively, aspects of the operations of 2005 may be performed by the device 1505 in association with the at least one processor 1535 executing the code 1530 stored in the at least one memory 1525, as described with reference to FIG. 15.

At 2010, the method may include transmitting one or more resource grants associated with the uplink beam report, the downlink beam report, or both in accordance with receiving the one or more uplink resource allocation requests. The operations of 2010 may be performed in accordance with examples as disclosed herein, such as in accordance with the transmission of the one or more resource grants at 625 of FIG. 6. The one or more resource grants may be examples of one or more resource grants 320 of FIG. 3. In some examples, aspects of the operations of 2010 may be performed by a resource grant component 1430 as described with reference to FIG. 14. Additionally, or alternatively, aspects of the operations of 2010 may be performed by the device 1505 in association with the at least one processor 1535 executing the code 1530 stored in the at least one memory 1525, as described with reference to FIG. 15.

At 2015, the method may include receiving, via a set of uplink resources allocated by the one or more resource grants, the uplink beam report, the downlink beam report, or both. The operations of 2015 may be performed in accordance with examples as disclosed herein, such as in accordance with the reception of the uplink beam report, the downlink beam report, or both at 630 of FIG. 6. The uplink beam report may be an example of the uplink beam report 325 of FIG. 3. In some examples, aspects of the operations of 2015 may be performed by a beam report component 1435 as described with reference to FIG. 14. Additionally, or alternatively, aspects of the operations of 2015 may be performed by the device 1505 in association with the at least one processor 1535 executing the code 1530 stored in the at least one memory 1525, as described with reference to FIG. 15.

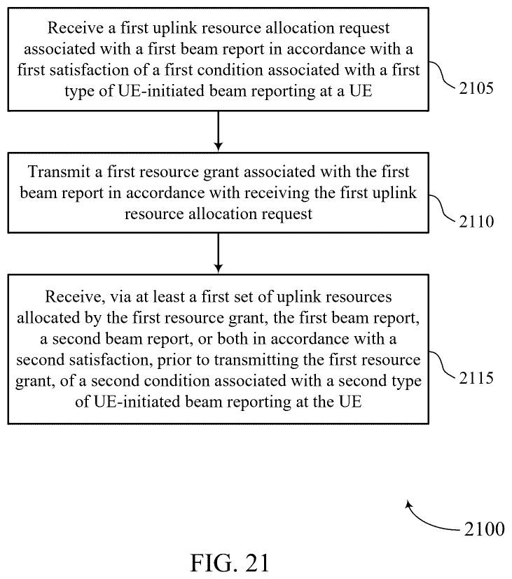

FIG. 21 shows a flowchart illustrating a method 2100 that supports multiple resource allocation requests in UE-initiated beam reporting in accordance with one or more aspects of the present disclosure. The operations of the method 2100 may be implemented by a network entity or its components as described herein. For example, the operations of the method 2100 may be performed by a network entity as described with reference to FIGS. 1-7 and 12-15. In some examples, a network entity may execute a set of instructions to control the functional elements of the network entity to perform the described functions. Additionally, or alternatively, the network entity may perform aspects of the described functions using special-purpose hardware.

At 2105, the method may include receiving a first uplink resource allocation request associated with a first beam report in accordance with a first satisfaction of a first condition associated with a first type of UE-initiated beam reporting at a UE. The operations of 2105 may be performed in accordance with examples as disclosed herein, such as in accordance with the reception of the first uplink resource allocation request at 715 of FIG. 7. The first uplink resource allocation request may be an example of the uplink resource allocation request 315 of FIG. 3. In some examples, aspects of the operations of 2105 may be performed by a resource request component 1425 as described with reference to FIG. 14. Additionally, or alternatively, aspects of the operations of 2105 may be performed by the device 1505 in association with the at least one processor 1535 executing the code 1530 stored in the at least one memory 1525, as described with reference to FIG. 15.

At 2110, the method may include transmitting a first resource grant associated with the first beam report in accordance with receiving the first uplink resource allocation request. The operations of 2110 may be performed in accordance with examples as disclosed herein, such as in accordance with the transmission of the first resource grant at 725 of FIG. 7. The first resource grant may be an example of the resource grant 320 of FIG. 3. In some examples, aspects of the operations of 2110 may be performed by a resource grant component 1430 as described with reference to FIG. 14. Additionally, or alternatively, aspects of the operations of 2110 may be performed by the device 1505 in association with the at least one processor 1535 executing the code 1530 stored in the at least one memory 1525, as described with reference to FIG. 15.

At 2115, the method may include receiving, via at least a first set of uplink resources allocated by the first resource grant, the first beam report, a second beam report, or both in accordance with a second satisfaction, prior to transmitting the first resource grant, of a second condition associated with a second type of UE-initiated beam reporting at the UE. The operations of 2115 may be performed in accordance with examples as disclosed herein, such as in accordance with the reception of the one or more beam reports at 740 of FIG. 7. The first beam report may be an example of an uplink beam report or a downlink beam report, and the second beam report may be an example of the other of the uplink beam report or the downlink beam report. In some examples, aspects of the operations of 2115 may be performed by a beam report component 1435 as described with reference to FIG. 14. Additionally, or alternatively, aspects of the operations of 2115 may be performed by the device 1505 in association with the at least one processor 1535 executing the code 1530 stored in the at least one memory 1525, as described with reference to FIG. 15.

The following provides an overview of aspects of the present disclosure:

Aspect 1: A method for wireless communications at a UE, comprising: transmitting a first uplink resource allocation request associated with an uplink beam report in accordance with a satisfaction of a condition associated with UE-initiated uplink beam reporting at the UE; monitoring, within a time period indicated by a timer that restricts uplink resource allocation requests associated with UE-initiated uplink beam reports, a downlink control channel for a resource grant associated with the uplink beam report in accordance with transmitting the first uplink resource allocation request; and transmitting a second uplink resource allocation request associated with the uplink beam report in accordance with an absence of the resource grant and an expiration of the timer that restricts the uplink resource allocation requests associated with the UE-initiated uplink beam reports.

Aspect 2: The method of aspect 1, further comprising: receiving, via control signaling, an indication of the timer that restricts the uplink resource allocation requests associated with the UE-initiated uplink beam reports.

Aspect 3: The method of any of aspects 1-2, further comprising: receiving an indication of an SCS associated with communications at the UE, wherein the time period indicated by the timer that restricts the uplink resource allocation requests associated with the UE-initiated uplink beam reports is in accordance with the subcarrier spacing.

Aspect 4: The method of any of aspects 1-3, wherein the time period indicated by the timer that restricts the uplink resource allocation requests associated with the UE-initiated uplink beam reports is fixed and applicable to a plurality of UEs of a wireless communications system comprising the UE.

Aspect 5: The method of any of aspects 1-4, further comprising: transmitting up to a threshold quantity of uplink resource allocation requests associated with the uplink beam report in accordance with a continued absence of the resource grant; and initiating a beam failure recovery procedure based at least in part on a failure to receive the resource grant in accordance with transmitting the threshold quantity of uplink resource allocation requests.

Aspect 6: The method of any of aspects 1-5, further comprising: transmitting a plurality of uplink resource allocation requests associated with the uplink beam report in accordance with a continued absence of the resource grant until a threshold time period from the first uplink resource allocation request is exceeded; and initiating a beam failure recovery procedure based at least in part on a failure to receive the resource grant in accordance with transmitting the plurality of uplink resource allocation requests until the threshold time period from the first uplink resource allocation request is exceeded.

Aspect 7: The method of any of aspects 1-6, wherein the uplink beam report comprises information indicative of one or more uplink metrics associated with one or more reference signals.

Aspect 8: The method of any of aspects 1-7, wherein the time period indicated by the timer starts from a first time at which the UE transmits the first uplink resource allocation request or from an offset relative to the first time, and the timer expires at or prior to a second time at which the UE transmits the second uplink resource allocation request.

Aspect 9: A method for wireless communications at a UE, comprising: transmitting one or more uplink resource allocation requests associated with an uplink beam report, a downlink beam report, or both in accordance with a first satisfaction of a first condition associated with UE-initiated uplink beam reporting at the UE and a second satisfaction of a second condition associated with UE-initiated downlink beam reporting at the UE, wherein the first satisfaction of the first condition and the second satisfaction of the second condition occur within a threshold duration of each other; receiving one or more resource grants associated with the uplink beam report, the downlink beam report, or both in accordance with transmitting the one or more uplink resource allocation requests; and transmitting, via a set of uplink resources allocated by the one or more resource grants, the uplink beam report, the downlink beam report, or both.

Aspect 10: The method of aspect 9, wherein transmitting the one or more uplink resource allocation requests comprises: transmitting a first uplink resource allocation request associated with the uplink beam report in accordance with the first satisfaction of the first condition; and transmitting a second uplink resource allocation request associated with the downlink beam report in accordance with the second satisfaction of the second condition.

Aspect 11: The method of aspect 10, wherein transmitting the first uplink resource allocation request and the second uplink resource allocation request is in accordance with a rule, and the rule defines separate uplink resource allocation requests associated with the UE-initiated uplink beam reporting and the UE-initiated downlink beam reporting independent of a timing between the first satisfaction of the first condition and the second satisfaction of the second condition.

Aspect 12: The method of any of aspects 10-11, wherein receiving the one or more resource grants comprises: receiving a first resource grant associated with the uplink beam report, wherein the first resource grant allocates a first set of uplink resources via which the UE transmits the uplink beam report; and receiving a second resource grant associated with the downlink beam report, wherein the second resource grant allocates a second set of uplink resources via which the UE transmits the downlink beam report.

Aspect 13: The method of any of aspects 10-12, wherein the UE-initiated uplink beam reporting is associated with a first set of one or more timers, a first set of one or more configurations, or a first set of one or more resources; and the UE-initiated downlink beam reporting is associated with a second set of one or more timers, a second set of one or more configurations, or a second set of one or more resources.

Aspect 14: The method of aspect 9, wherein transmitting the one or more uplink resource allocation requests comprises: transmitting a single uplink resource allocation request in accordance with the first satisfaction of the first condition and the second satisfaction of the second condition occurring within the threshold duration of each other.

Aspect 15: The method of aspect 14, wherein receiving the one or more resource grants comprises: receiving a single resource grant in accordance with transmitting the single uplink resource allocation request, wherein the single resource grant allocates the set of uplink resources, and wherein the UE transmits the uplink beam report, the downlink beam report, or both as an uplink-only beam report, a downlink-only beam report, or a joint uplink and downlink beam report.

Aspect 16: The method of aspect 15, further comprising: selecting the uplink beam report, the downlink beam report, or both for transmission via the set of uplink resources in accordance with an autonomous UE decision or a relative priority between the uplink beam report and the downlink beam report.

Aspect 17: The method of any of aspects 9 or 14-16, wherein transmitting the one or more uplink resource allocation requests comprises: transmitting a single uplink resource allocation request via a first uplink control channel resource, of a plurality of uplink control channel resources, in accordance with the first satisfaction of the first condition and the second satisfaction of the second condition occurring within the threshold duration of each other, wherein the first uplink control channel resource indicates that a requested resource is associated with a joint uplink and downlink beam report, and wherein other uplink control channel resources of the plurality of uplink control channel resources indicate that the requested resource is associated with an uplink-only beam report or a downlink-only beam report.

Aspect 18: The method of aspect 17, wherein receiving the one or more resource grants comprises: receiving a single resource grant in accordance with transmitting the single uplink resource allocation request, wherein the single resource grant allocates the set of uplink resources, and wherein the UE transmits the uplink beam report and the downlink beam report as the joint uplink and downlink beam report in accordance with transmitting the single uplink resource allocation request via the first uplink control channel resource.

Aspect 19: The method of any of aspects 17-18, further comprising: receiving, via control signaling, an indication of the first uplink control channel resource that indicates that the requested resource is associated with the joint uplink and downlink beam report, wherein the control signaling configures the first uplink control channel resource as a periodic uplink control channel resource or a semi-persistent uplink control channel resource.

Aspect 20: The method of any of aspects 9 or 14-19, wherein transmitting the one or more uplink resource allocation requests comprises: transmitting a single uplink resource allocation request in accordance with the first satisfaction of the first condition and the second satisfaction of the second condition occurring within the threshold duration of each other, wherein the single uplink resource allocation request comprises an indication, via one or more bits of the single uplink resource allocation request, that the first satisfaction of the first condition and the second satisfaction of the second condition occurred within the threshold duration of each other.

Aspect 21: The method of aspect 20, wherein receiving the one or more resource grants comprises: receiving a single resource grant in accordance with the indication, wherein the single resource grant allocates the set of uplink resources, and wherein the UE transmits the uplink beam report and the downlink beam report as a joint uplink and downlink beam report.

Aspect 22: The method of any of aspects 20-21, wherein a bitword associated with the one or more bits indicates whether a requested resource is associated with an uplink-only beam report, a downlink-only beam report, or a joint uplink and downlink beam report.

Aspect 23: The method of any of aspects 9-22, wherein the uplink beam report comprises first information indicative of one or more uplink metrics associated with one or more first reference signals; and the downlink beam report comprises second information indicative of one or more downlink metrics associated with one or more second reference signals.

Aspect 24: The method of any of aspects 9-23, wherein the threshold duration is defined by a difference between a first time at which the first satisfaction of the first condition or the second satisfaction of the second condition occurs and a second time at which the UE transmits the one or more uplink resource allocation requests, or is defined by a timer that restricts resource allocation requests associated with UE-initiated uplink beam reports or UE-initiated downlink beam reports.

Aspect 25: A method for wireless communications at a UE, comprising: transmitting a first uplink resource allocation request associated with a first beam report in accordance with a first satisfaction of a first condition associated with a first type of UE-initiated beam reporting at the UE; receiving a first resource grant associated with the first beam report in accordance with transmitting the first uplink resource allocation request; and transmitting, via at least a first set of uplink resources allocated by the first resource grant, the first beam report, a second beam report, or both in accordance with a second satisfaction, prior to receiving the first resource grant, of a second condition associated with a second type of UE-initiated beam reporting at the UE.

Aspect 26: The method of aspect 25, further comprising: transmitting a second uplink resource allocation request associated with the second beam report in accordance with the second satisfaction of the second condition associated with the second type of UE-initiated beam reporting at the UE; and receiving a second resource grant associated with the second beam report in accordance with transmitting the second uplink resource allocation request.

Aspect 27: The method of aspect 26, wherein transmitting the first beam report, the second beam report, or both comprises: transmitting the first beam report via the first set of uplink resources allocated by the first resource grant; and transmitting the second beam report via a second set of uplink resources allocated by the second resource grant.

Aspect 28: The method of any of aspects 25-27, further comprising: multiplexing a second uplink resource allocation request associated with the second beam report with the first beam report; and receiving a second resource grant associated with the second beam report in accordance with multiplexing the second uplink resource allocation request with the first beam report.

Aspect 29: The method of aspect 28, wherein transmitting the first beam report, the second beam report, or both comprises: transmitting the first beam report and the second uplink resource allocation request via the first set of uplink resources allocated by the first resource grant; and transmitting the second beam report via a second set of uplink resources allocated by the second resource grant.

Aspect 30: The method of any of aspects 25-29, further comprising: multiplexing the first beam report and the second beam report to the first set of uplink resources allocated by the first resource grant, wherein the UE allocates uplink resources, from the first set of uplink resources, to the first beam report and the second beam report in accordance with a relative priority between the first beam report and the second beam report.

Aspect 31: The method of aspect 30, wherein the UE prioritizes resource allocation to the first beam report in accordance with the first beam report having a higher priority than the second beam report.

Aspect 32: The method of any of aspects 25-31, wherein the UE transmits the first beam report and the second beam report via the first set of uplink resources allocated by the first resource grant as a joint beam report.

Aspect 33: The method of any of aspects 25-32, wherein the first beam report is a downlink beam report, and the first type of UE-initiated beam reporting is UE-initiated downlink beam reporting; and the second beam report is an uplink beam report, and the second type of UE-initiated beam reporting is UE-initiated uplink beam reporting.

Aspect 34: The method of any of aspects 25-33, wherein the first beam report is an uplink beam report, and the first type of UE-initiated beam reporting is UE-initiated uplink beam reporting; and the second beam report is a downlink beam report, and the second type of UE-initiated beam reporting is UE-initiated downlink beam reporting.

Aspect 35: A method for wireless communications at a network entity, comprising: receiving a first uplink resource allocation request associated with an uplink beam report in accordance with a satisfaction of a condition associated with UE-initiated uplink beam reporting at a UE; transmitting, within a time period indicated by a timer that restricts uplink resource allocation requests associated with UE-initiated uplink beam reports, a resource grant associated with the uplink beam report in accordance with receiving the first uplink resource allocation request; and receiving a second uplink resource allocation request associated with the uplink beam report in accordance with a reception failure of the resource grant at the UE and an expiration of the timer that restricts the uplink resource allocation requests associated with the UE-initiated uplink beam reports.

Aspect 36: The method of aspect 35, further comprising: transmitting, via control signaling, an indication of the timer that restricts the uplink resource allocation requests associated with the UE-initiated uplink beam reports.

Aspect 37: The method of any of aspects 35-36, further comprising: transmitting an indication of an SCS associated with communications at the UE, wherein the time period indicated by the timer that restricts the uplink resource allocation requests associated with the UE-initiated uplink beam reports is in accordance with the subcarrier spacing.

Aspect 38: The method of any of aspects 35-37, wherein the time period indicated by the timer that restricts the uplink resource allocation requests associated with the UE-initiated uplink beam reports is fixed and applicable to a plurality of UEs of a wireless communications system comprising the UE.

Aspect 39: The method of any of aspects 35-38, further comprising: receiving up to a threshold quantity of uplink resource allocation requests associated with the uplink beam report in accordance with a continued reception failure of the resource grant at the UE; and participating in a beam failure recovery procedure with the UE based at least in part on receiving the threshold quantity of uplink resource allocation requests.

Aspect 40: The method of any of aspects 35-39, further comprising: receiving a plurality of uplink resource allocation requests associated with the uplink beam report in accordance with a continued reception failure of the resource grant at the UE until a threshold time period from the first uplink resource allocation request is exceeded; and participating in a beam failure recovery procedure with the UE based at least in part on the threshold time period from the first uplink resource allocation request being exceeded prior to a successful reception of the resource grant at the UE.

Aspect 41: The method of any of aspects 35-40, wherein the uplink beam report comprises information indicative of one or more uplink metrics associated with one or more reference signals.

Aspect 42: The method of any of aspects 35-41, wherein the time period indicated by the timer starts from a first time at which the network entity receives the first uplink resource allocation request or from an offset relative to the first time, and the timer expires at or prior to a second time at which the network entity receives the second uplink resource allocation request.

Aspect 43: A method for wireless communications at a network entity, comprising: receiving one or more uplink resource allocation requests associated with an uplink beam report, a downlink beam report, or both in accordance with a first satisfaction of a first condition associated with UE-initiated uplink beam reporting at a UE and a second satisfaction of a second condition associated with UE-initiated downlink beam reporting at the UE, wherein the first satisfaction of the first condition and the second satisfaction of the second condition occur within a threshold duration of each other; transmitting one or more resource grants associated with the uplink beam report, the downlink beam report, or both in accordance with receiving the one or more uplink resource allocation requests; and receiving, via a set of uplink resources allocated by the one or more resource grants, the uplink beam report, the downlink beam report, or both.

Aspect 44: The method of aspect 43, wherein receiving the one or more uplink resource allocation requests comprises: receiving a first uplink resource allocation request associated with the uplink beam report in accordance with the first satisfaction of the first condition; and receiving a second uplink resource allocation request associated with the downlink beam report in accordance with the second satisfaction of the second condition.

Aspect 45: The method of aspect 44, wherein receiving the first uplink resource allocation request and the second uplink resource allocation request is in accordance with a rule, and the rule defines separate uplink resource allocation requests associated with the UE-initiated uplink beam reporting and the UE-initiated downlink beam reporting independent of a timing between the first satisfaction of the first condition and the second satisfaction of the second condition.

Aspect 46: The method of any of aspects 44-45, wherein transmitting the one or more resource grants comprises: transmitting a first resource grant associated with the uplink beam report, wherein the first resource grant allocates a first set of uplink resources via which the UE is to transmit the uplink beam report; and transmitting a second resource grant associated with the downlink beam report, wherein the second resource grant allocates a second set of uplink resources via which the UE is to transmit the downlink beam report.

Aspect 47: The method of any of aspects 44-46, wherein the UE-initiated uplink beam reporting is associated with a first set of one or more timers, a first set of one or more configurations, or a first set of one or more resources; and the UE-initiated downlink beam reporting is associated with a second set of one or more timers, a second set of one or more configurations, or a second set of one or more resources.

Aspect 48: The method of aspect 43, wherein receiving the one or more uplink resource allocation requests comprises: receiving a single uplink resource allocation request in accordance with the first satisfaction of the first condition and the second satisfaction of the second condition occurring within the threshold duration of each other.

Aspect 49: The method of aspect 48, wherein transmitting the one or more resource grants comprises: transmitting a single resource grant in accordance with receiving the single uplink resource allocation request, wherein the single resource grant allocates the set of uplink resources, and wherein the network entity receives the uplink beam report, the downlink beam report, or both as an uplink-only beam report, a downlink-only beam report, or a joint uplink and downlink beam report.

Aspect 50: The method of aspect 49, wherein receiving the uplink beam report, the downlink beam report, or both comprises: receiving the uplink beam report, the downlink beam report, or both via the set of uplink resources in accordance with an autonomous UE decision or a relative priority between the uplink beam report and the downlink beam report.

Aspect 51: The method of any of aspects 43 or 48-50, wherein receiving the one or more uplink resource allocation requests comprises: receiving a single uplink resource allocation request via a first uplink control channel resource, of a plurality of uplink control channel resources, in accordance with the first satisfaction of the first condition and the second satisfaction of the second condition occurring within the threshold duration of each other, wherein the first uplink control channel resource indicates that a requested resource is associated with a joint uplink and downlink beam report, and wherein other uplink control channel resources of the plurality of uplink control channel resources indicate that the requested resource is associated with an uplink-only beam report or a downlink-only beam report.

Aspect 52: The method of aspect 51, wherein transmitting the one or more resource grants comprises: transmitting a single resource grant in accordance with receiving the single uplink resource allocation request, wherein the single resource grant allocates the set of uplink resources, and wherein the network entity receives the uplink beam report and the downlink beam report as the joint uplink and downlink beam report in accordance with receiving the single uplink resource allocation request via the first uplink control channel resource.

Aspect 53: The method of any of aspects 51-52, further comprising: transmitting, via control signaling, an indication of the first uplink control channel resource that indicates that the requested resource is associated with the joint uplink and downlink beam report, wherein the control signaling configures the first uplink control channel resource as a periodic uplink control channel resource or a semi-persistent uplink control channel resource.

Aspect 54: The method of any of aspects 43 or 48-53, wherein receiving the one or more uplink resource allocation requests comprises: receiving a single uplink resource allocation request in accordance with the first satisfaction of the first condition and the second satisfaction of the second condition occurring within the threshold duration of each other, wherein the single uplink resource allocation request comprises an indication, via one or more bits of the single uplink resource allocation request, that the first satisfaction of the first condition and the second satisfaction of the second condition occurred within the threshold duration of each other.

Aspect 55: The method of aspect 54, wherein transmitting the one or more resource grants comprises: transmitting a single resource grant in accordance with the indication, wherein the single resource grant allocates the set of uplink resources, and wherein the network entity receives the uplink beam report and the downlink beam report as a joint uplink and downlink beam report.

Aspect 56: The method of any of aspects 54-55, wherein a bitword associated with the one or more bits indicates whether a requested resource is associated with an uplink-only beam report, a downlink-only beam report, or a joint uplink and downlink beam report.

Aspect 57: The method of any of aspects 43-56, wherein the uplink beam report comprises first information indicative of one or more uplink metrics associated with one or more first reference signals; and the downlink beam report comprises second information indicative of one or more downlink metrics associated with one or more second reference signals.

Aspect 58: The method of any of aspects 43-57, wherein the threshold duration is defined by a difference between a first time at which the first satisfaction of the first condition or the second satisfaction of the second condition occurs and a second time at which the UE transmits the one or more uplink resource allocation requests, or is defined by a timer that restricts resource allocation requests associated with UE-initiated uplink beam reports or UE-initiated downlink beam reports.

Aspect 59: A method for wireless communications at a network entity, comprising: receiving a first uplink resource allocation request associated with a first beam report in accordance with a first satisfaction of a first condition associated with a first type of UE-initiated beam reporting at a UE; transmitting a first resource grant associated with the first beam report in accordance with receiving the first uplink resource allocation request; and receiving, via at least a first set of uplink resources allocated by the first resource grant, the first beam report, a second beam report, or both in accordance with a second satisfaction, prior to transmitting the first resource grant, of a second condition associated with a second type of UE-initiated beam reporting at the UE.

Aspect 60: The method of aspect 59, further comprising: receiving a second uplink resource allocation request associated with the second beam report in accordance with the second satisfaction of the second condition associated with the second type of UE-initiated beam reporting at the UE; and transmitting a second resource grant associated with the second beam report in accordance with receiving the second uplink resource allocation request.

Aspect 61: The method of aspect 60, wherein receiving the first beam report, the second beam report, or both comprises: receiving the first beam report via the first set of uplink resources allocated by the first resource grant; and receiving the second beam report via a second set of uplink resources allocated by the second resource grant.

Aspect 62: The method of any of aspects 59-61, further comprising: demultiplexing a second uplink resource allocation request associated with the second beam report from the first beam report; and transmitting a second resource grant associated with the second beam report in accordance with demultiplexing the second uplink resource allocation request from the first beam report.

Aspect 63: The method of aspect 62, wherein receiving the first beam report, the second beam report, or both comprises: receiving the first beam report and the second uplink resource allocation request via the first set of uplink resources allocated by the first resource grant; and receiving the second beam report via a second set of uplink resources allocated by the second resource grant.

Aspect 64: The method of any of aspects 59-63, further comprising: demultiplexing the first beam report and the second beam report from the first set of uplink resources allocated by the first resource grant, wherein uplink resources, from the first set of uplink resources, are allocated to the first beam report and the second beam report in accordance with a relative priority between the first beam report and the second beam report.

Aspect 65: The method of aspect 64, wherein resource allocation to the first beam report is prioritized in accordance with the first beam report having a higher priority than the second beam report.

Aspect 66: The method of any of aspects 59-65, wherein the network entity receives the first beam report and the second beam report via the first set of uplink resources allocated by the first resource grant as a joint beam report.

Aspect 67: The method of any of aspects 59-66, wherein the first beam report is a downlink beam report, and the first type of UE-initiated beam reporting is UE-initiated downlink beam reporting; and the second beam report is an uplink beam report, and the second type of UE-initiated beam reporting is UE-initiated uplink beam reporting.

Aspect 68: The method of any of aspects 59-67, wherein the first beam report is an uplink beam report, and the first type of UE-initiated beam reporting is UE-initiated uplink beam reporting; and the second beam report is a downlink beam report, and the second type of UE-initiated beam reporting is UE-initiated downlink beam reporting.

Aspect 69: A UE for wireless communications, comprising one or more memories storing processor-executable code, and one or more processors coupled with the one or more memories and individually or collectively operable to execute the code to cause the UE to perform a method of any of aspects 1-8.

Aspect 70: A UE for wireless communications, comprising at least one means for performing a method of any of aspects 1-8.

Aspect 71: A non-transitory computer-readable medium storing code for wireless communications, the code comprising instructions executable by one or more processors to perform a method of any of aspects 1-8.

Aspect 72: A UE for wireless communications, comprising one or more memories storing processor-executable code, and one or more processors coupled with the one or more memories and individually or collectively operable to execute the code to cause the UE to perform a method of any of aspects 9-24.

Aspect 73: A UE for wireless communications, comprising at least one means for performing a method of any of aspects 9-24.

Aspect 74: A non-transitory computer-readable medium storing code for wireless communications, the code comprising instructions executable by one or more processors to perform a method of any of aspects 9-24.

Aspect 75: A UE for wireless communications, comprising one or more memories storing processor-executable code, and one or more processors coupled with the one or more memories and individually or collectively operable to execute the code to cause the UE to perform a method of any of aspects 25-34.

Aspect 76: A UE for wireless communications, comprising at least one means for performing a method of any of aspects 25-34.

Aspect 77: A non-transitory computer-readable medium storing code for wireless communications, the code comprising instructions executable by one or more processors to perform a method of any of aspects 25-34.

Aspect 78: A network entity for wireless communications, comprising one or more memories storing processor-executable code, and one or more processors coupled with the one or more memories and individually or collectively operable to execute the code to cause the network entity to perform a method of any of aspects 35-42.

Aspect 79: A network entity for wireless communications, comprising at least one means for performing a method of any of aspects 35-42.

Aspect 80: A non-transitory computer-readable medium storing code for wireless communications, the code comprising instructions executable by one or more processors to perform a method of any of aspects 35-42.

Aspect 81: A network entity for wireless communications, comprising one or more memories storing processor-executable code, and one or more processors coupled with the one or more memories and individually or collectively operable to execute the code to cause the network entity to perform a method of any of aspects 43-58.

Aspect 82: A network entity for wireless communications, comprising at least one means for performing a method of any of aspects 43-58.

Aspect 83: A non-transitory computer-readable medium storing code for wireless communications, the code comprising instructions executable by one or more processors to perform a method of any of aspects 43-58.

Aspect 84: A network entity for wireless communications, comprising one or more memories storing processor-executable code, and one or more processors coupled with the one or more memories and individually or collectively operable to execute the code to cause the network entity to perform a method of any of aspects 59-68.

Aspect 85: A network entity for wireless communications, comprising at least one means for performing a method of any of aspects 59-68.

Aspect 86: A non-transitory computer-readable medium storing code for wireless communications, the code comprising instructions executable by one or more processors to perform a method of any of aspects 59-68.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a first uplink resource allocation request associated with an uplink beam report in accordance with a satisfaction of a condition associated with UE-initiated uplink beam reporting at the UE;
monitor, within a time period indicated by a timer that restricts uplink resource allocation requests associated with UE-initiated uplink beam reports, a downlink control channel for a resource grant associated with the uplink beam report in accordance with transmitting the first uplink resource allocation request; and
transmit a second uplink resource allocation request associated with the uplink beam report in accordance with an absence of the resource grant and an expiration of the timer that restricts the uplink resource allocation requests associated with the UE-initiated uplink beam reports.

2. The UE of claim 1, wherein the one or more processors are individually or collectively further operable to execute the code to cause the UE to:
receive, via control signaling, an indication of the timer that restricts the uplink resource allocation requests associated with the UE-initiated uplink beam reports.

3. The UE of claim 1, wherein the one or more processors are individually or collectively further operable to execute the code to cause the UE to:
receive an indication of a subcarrier spacing associated with communications at the UE, wherein the time period indicated by the timer that restricts the uplink resource allocation requests associated with the UE-initiated uplink beam reports is in accordance with the subcarrier spacing.

4. The UE of claim 1, wherein the time period indicated by the timer that restricts the uplink resource allocation requests associated with the UE-initiated uplink beam reports is fixed and applicable to a plurality of UEs of a wireless communications system comprising the UE.

5. The UE of claim 1, wherein the one or more processors are individually or collectively further operable to execute the code to cause the UE to:
transmit up to a threshold quantity of uplink resource allocation requests associated with the uplink beam report in accordance with a continued absence of the resource grant; and
initiate a beam failure recovery procedure based at least in part on a failure to receive the resource grant in accordance with transmitting the threshold quantity of uplink resource allocation requests.

6. The UE of claim 1, wherein the one or more processors are individually or collectively further operable to execute the code to cause the UE to:
transmit a plurality of uplink resource allocation requests associated with the uplink beam report in accordance with a continued absence of the resource grant until a threshold time period from the first uplink resource allocation request is exceeded; and
initiate a beam failure recovery procedure based at least in part on a failure to receive the resource grant in accordance with transmitting the plurality of uplink resource allocation requests until the threshold time period from the first uplink resource allocation request is exceeded.

7. The UE of claim 1, wherein the uplink beam report comprises information indicative of one or more uplink metrics associated with one or more reference signals.

8. The UE of claim 1, wherein the time period indicated by the timer starts from a first time at which the UE transmits the first uplink resource allocation request or from an offset relative to the first time, and wherein the timer expires at or prior to a second time at which the UE transmits the second uplink resource allocation request.

9. A network entity, comprising:
one or more memories storing processor-executable code; and
one or more processors coupled with the one or more memories and individually or collectively operable to execute the code to cause the network entity to:
obtain a first uplink resource allocation request associated with an uplink beam report in accordance with a satisfaction of a condition associated with user equipment (UE)-initiated uplink beam reporting at a UE;
output, within a time period indicated by a timer that restricts uplink resource allocation requests associated with UE-initiated uplink beam reports, a resource grant associated with the uplink beam report in accordance with obtaining the first uplink resource allocation request; and
obtain a second uplink resource allocation request associated with the uplink beam report in accordance with a reception failure of the resource grant at the UE and an expiration of the timer that restricts the uplink resource allocation requests associated with the UE-initiated uplink beam reports.

10. The network entity of claim 9, wherein the one or more processors are individually or collectively further operable to execute the code to cause the network entity to:
output, via control signaling, an indication of the timer that restricts the uplink resource allocation requests associated with the UE-initiated uplink beam reports.

11. The network entity of claim 9, wherein the one or more processors are individually or collectively further operable to execute the code to cause the network entity to:
output an indication of a subcarrier spacing associated with communications at the UE, wherein the time period indicated by the timer that restricts the uplink resource allocation requests associated with the UE-initiated uplink beam reports is in accordance with the subcarrier spacing.

12. The network entity of claim 9, wherein the time period indicated by the timer that restricts the uplink resource allocation requests associated with the UE-initiated uplink beam reports is fixed and applicable to a plurality of UEs of a wireless communications system comprising the UE.

13. The network entity of claim 9, wherein the one or more processors are individually or collectively further operable to execute the code to cause the network entity to:
obtain up to a threshold quantity of uplink resource allocation requests associated with the uplink beam report in accordance with a continued reception failure of the resource grant at the UE; and
participate in a beam failure recovery procedure with the UE based at least in part on obtaining the threshold quantity of uplink resource allocation requests.

14. The network entity of claim 9, wherein the one or more processors are individually or collectively further operable to execute the code to cause the network entity to:
obtain a plurality of uplink resource allocation requests associated with the uplink beam report in accordance with a continued reception failure of the resource grant at the UE until a threshold time period from the first uplink resource allocation request is exceeded; and
participate in a beam failure recovery procedure with the UE based at least in part on the threshold time period from the first uplink resource allocation request being exceeded prior to a successful reception of the resource grant at the UE.

15. The network entity of claim 9, wherein the uplink beam report comprises information indicative of one or more uplink metrics associated with one or more reference signals.

16. The network entity of claim 9, wherein the time period indicated by the timer starts from a first time at which the network entity receives the first uplink resource allocation request or from an offset relative to the first time, and wherein the timer expires at or prior to a second time at which the network entity receives the second uplink resource allocation request.

17. A method for wireless communications at a user equipment (UE), comprising:
transmitting a first uplink resource allocation request associated with an uplink beam report in accordance with a satisfaction of a condition associated with UE-initiated uplink beam reporting at the UE;
monitoring, within a time period indicated by a timer that restricts uplink resource allocation requests associated with UE-initiated uplink beam reports, a downlink control channel for a resource grant associated with the uplink beam report in accordance with transmitting the first uplink resource allocation request; and
transmitting a second uplink resource allocation request associated with the uplink beam report in accordance with an absence of the resource grant and an expiration of the timer that restricts the uplink resource allocation requests associated with the UE-initiated uplink beam reports.

18. The method of claim 17, further comprising:
receiving, via control signaling, an indication of the timer that restricts the uplink resource allocation requests associated with the UE-initiated uplink beam reports.

19. The method of claim 17, further comprising:
receiving an indication of a subcarrier spacing associated with communications at the UE, wherein the time period indicated by the timer that restricts the uplink resource allocation requests associated with the UE-initiated uplink beam reports is in accordance with the subcarrier spacing.

20. The method of claim 17, wherein the time period indicated by the timer that restricts the uplink resource allocation requests associated with the UE-initiated uplink beam reports is fixed and applicable to a plurality of UEs of a wireless communications system comprising the UE.

21. The method of claim 17, further comprising:
transmitting up to a threshold quantity of uplink resource allocation requests associated with the uplink beam report in accordance with a continued absence of the resource grant; and
initiating a beam failure recovery procedure based at least in part on a failure to receive the resource grant in accordance with transmitting the threshold quantity of uplink resource allocation requests.

22. The method of claim 17, further comprising:
transmitting a plurality of uplink resource allocation requests associated with the uplink beam report in accordance with a continued absence of the resource grant until a threshold time period from the first uplink resource allocation request is exceeded; and
initiating a beam failure recovery procedure based at least in part on a failure to receive the resource grant in accordance with transmitting the plurality of uplink resource allocation requests until the threshold time period from the first uplink resource allocation request is exceeded.

23. The method of claim 17, wherein the uplink beam report comprises information indicative of one or more uplink metrics associated with one or more reference signals.

24. The method of claim 17, wherein the time period indicated by the timer starts from a first time at which the UE transmits the first uplink resource allocation request or from an offset relative to the first time, and wherein the timer expires at or prior to a second time at which the UE transmits the second uplink resource allocation request.

25. A method for wireless communications at a network entity, comprising:
obtaining a first uplink resource allocation request associated with an uplink beam report in accordance with a satisfaction of a condition associated with user equipment (UE)-initiated uplink beam reporting at a UE;
outputting, within a time period indicated by a timer that restricts uplink resource allocation requests associated with UE-initiated uplink beam reports, a resource grant associated with the uplink beam report in accordance with obtaining the first uplink resource allocation request; and
obtaining a second uplink resource allocation request associated with the uplink beam report in accordance with a reception failure of the resource grant at the UE and an expiration of the timer that restricts the uplink resource allocation requests associated with the UE-initiated uplink beam reports.

26. The method of claim 25, further comprising:
outputting, via control signaling, an indication of the timer that restricts the uplink resource allocation requests associated with the UE-initiated uplink beam reports.

27. The method of claim 25, further comprising:
outputting an indication of a subcarrier spacing associated with communications at the UE, wherein the time period indicated by the timer that restricts the uplink resource allocation requests associated with the UE-initiated uplink beam reports is in accordance with the subcarrier spacing.

28. The method of claim 25, wherein the time period indicated by the timer that restricts the uplink resource allocation requests associated with the UE-initiated uplink beam reports is fixed and applicable to a plurality of UEs of a wireless communications system comprising the UE.

29. The method of claim 25, further comprising:
obtaining up to a threshold quantity of uplink resource allocation requests associated with the uplink beam report in accordance with a continued reception failure of the resource grant at the UE; and
participating in a beam failure recovery procedure with the UE based at least in part on obtaining the threshold quantity of uplink resource allocation requests.

30. The method of claim 25, further comprising:
obtaining a plurality of uplink resource allocation requests associated with the uplink beam report in accordance with a continued reception failure of the resource grant at the UE until a threshold time period from the first uplink resource allocation request is exceeded; and
participating in a beam failure recovery procedure with the UE based at least in part on the threshold time period from the first uplink resource allocation request being exceeded prior to a successful reception of the resource grant at the UE.
